(19) United States
(12) Patent Application Publication
(10) Pub. No.: US 2019/0286770 A1
(43) Pub. Date: Sep. 19, 2019

(54) COMPUTER-READABLE RECORDING MEDIUM STORING DIVIDED REGION GENERATING PROGRAM, DIVIDED REGION GENERATING APPARATUS, AND DIVIDED REGION GENERATING METHOD

(71) Applicant: FUJITSU LIMITED, Kawasaki-shi (JP)

(72) Inventor: Yusuke Oishi, Yokohama (JP)

(73) Assignee: FUJITSU LIMITED, Kawasaki-shi (JP)

(21) Appl. No.: 16/291,043

(22) Filed: Mar. 4, 2019

(30) Foreign Application Priority Data
Mar. 14, 2018 (JP) 2018-047217

(51) Int. Cl. G06F 17/50

(52) U.S. Cl. CPC G06F 17/5018; G06F 2217/16

(57) ABSTRACT

A computer-readable recording medium storing therein a program for causing a computer to execute a process that includes: generating a plurality of first gene-information point sets; deciding a plurality of first reference points on a boundary line and generating a plurality of first rectangular regions based on the first gene-information point sets; generating a plurality of second gene -information point sets using a genetic algorithm; for each of the plurality of second gene-information point sets, deciding a plurality of second reference points on the boundary line and generating a plurality of second rectangular regions; specifying one of the plurality of first gene-information point sets and the plurality of second gene-information point sets; and dividing a target region based on the plurality of first rectangular regions or the plurality of second rectangular regions generated according to the specified first gene-information point set or second gene-information point set.

### CROSS-REFERENCE TO RELATED APPLICATION

This application is based upon and claims the benefit of priority of the prior Japanese Patent Application No. 2018-47217, filed on Mar. 14, 2018, the entire contents of which are incorporated herein by reference.

### FIELD

The embodiments discussed herein are related to a computer -readable recording medium storing a divided region generating program, a divided region generating apparatus, and a divided region generating method.

### BACKGROUND

In the field of computational fluid dynamics (CFD), a computer is used to analyze the temporal variation of the state of a fluid. For example, the computer may be used to simulate the movement of the fluid around an automobile during the travel of the automobile. For example, a high -performance computer such as a supercomputer is used for the fluid calculation.

A mesh (grid) is generated in the space to be analyzed when the computer is used to perform the fluid calculation. The computer then calculates, for example, physical quantities (speed or pressure) of the fluid at lattice points of the mesh.

In the fluid calculation, the smaller the size of the mesh, the higher the calculation accuracy. On the other hand, when the size of the mesh is small, the amount of calculation increases, and the calculation takes a long time. Therefore, the size of the mesh may be reduced to perform detailed calculation near the boundary of an object (three-dimensional object such as an automobile and an airplane) arranged in the analysis space and the fluid, and the size of the mesh may be increased at a position away from the object.

Examples of the mesh used for the fluid calculation include an unstructured grid and a structured grid. The unstructured grid is a grid in which elements including polygons are irregularly arranged. The structured grid is a grid in which elements of hexahedrons are regularly arranged in each axial direction.

The geometric degree of freedom of the unstructured grid is high, and a different size may be easily set for each region. However, the unstructured grid has a disadvantage that high calculation performance may not be easily attained. It also takes a long time to generate the mesh when the unstructured grid is adopted.

On the other hand, the mesh may be easily generated for the structured grid, and the data may be regularly arranged on the memory. Therefore, high calculation performance may be easily attained. For example, it is important that the computer effectively utilizes a single instruction/multiple data (SIMD) computing unit suitable for processing of the structured grid in which the data access is continuous. The SIMD computing unit is a computing unit capable of executing a process of applying one command to a plurality of pieces of data at the same time to compute the data in parallel (SIMD computation). To efficiently perform the SIMD computation, the plurality of pieces of data to be processed in parallel may be stored in a continuous storage area in the memory. In the structured grid, the plurality of pieces of data subject to parallel processing may be easily arranged in the continuous area in the memory, and the efficiency of the process based on the SIMD computation may be easily increased.

Although the geometric degree of freedom of the mesh is low in the structured grid, a hierarchical structured grid may be used to change the size of the mesh for each region. The hierarchical structured grid is a structured grid including nested rectangular regions. For example, a high-resolution grid is set inside of a low-resolution grid in the hierarchical structured grid. As a result, a limited region may be analyzed at a high resolution.

An example of the analysis method using the mesh includes adaptive mesh refinement (AMR). The adaptive mesh refinement is an analysis method of rebuilding the mesh based on the gradient of the physical quantity obtained by the analysis. The resolution of a region with rapidly changing physical quantity may be accurately increased in the adaptive mesh refinement. However, the data structure on the computer may be complicated, or the memory addresses of the lattice points adjacent to each other may not be continuous in the adaptive mesh refinement. For these factors, the arrangement of the data to be continuously processed may not be continuous on the memory, or high calculation performance may not be attained by using the SIMD computing unit.

Note that numerical simulation is used, in various fields. For example, there is a system that provides temporally changing actual measurement values which are taken into account to estimate an accurate change in the indoor temperature. Various methods regarding efficient numerical analysis are also considered. For example, there is an electromagnetic field analyzing apparatus in which a fine calculation grid is not used in the entire region even for the analysis with a high spatial resolution in part of the region to be analyzed, and the amount of entire calculation is not increased. The speed of calculation may be increased, and the calculation cost for the highly accurate analysis may be reduced. There is also an information processing apparatus that may significantly reduce the number of divided elements in the finite element method. Furthermore, there is a grid data generating apparatus that may generate high-quality grid data.

Examples of related-art documents are Japanese Laid-open Patent Publication No. 2016-099104, Japanese Laid-open Patent Publication No. 2003-330977, Japanese Laid-open Patent Publication No. 2005-258812, and Japanese Laid-open Patent Publication No. 2011-134279.

### SUMMARY

According to an aspect of the embodiments, a non-transitory computer-readable recording medium storing therein a divided region generating program for causing a computer to execute a process that includes referring to boundary information indicating a boundary line of a region occupied by an object arranged in a target region and another region on a plane in the target region to generate a plurality of first gene information point sets each including a plurality of first gene information points, in which the number of the plurality of first gene information points corresponds to a first set value related to a degree of division of the target region; deciding a plurality of first reference points on the boundary line for each of the plurality of first gene information point sets based on the plurality of first gene information points included in the first gene information point set; generating a plurality of first rectangular regions for each of the plurality of first gene information point sets, in which each of the plurality of first gene rectangular regions is shaped by a side including one of the plurality of first reference points and a side not including any of the plurality of first reference points, and the side not including any of the plurality of first reference points and the boundary line are separated by a second set value indicating a distance to the boundary line; using a genetic algorithm based on a selected first gene information point set selected from the plurality of first gene information point sets to generate a plurality of second gene information point sets each including a plurality of second gene information points, in which the number of the plurality of second gene information points corresponds to the first set value; deciding a plurality of second reference points on the boundary line for each of the plurality of second gene information point sets based on the plurality of second gene information points included in the second gene information point set; generating a plurality of second rectangular regions for each of the plurality of second gene information point sets, in which each of the plurality of second rectangular regions is shaped by a side including one of the plurality of second reference points and a side not including any of the plurality of second reference points, and the side not including any of the plurality of second reference points and the boundary line are separated by the second set value; specifying one of the plurality of first gene information point sets and the plurality of second gene information point sets based on evaluation of the plurality of first rectangular regions generated based on the first gene information point set for each of the plurality of first gene information point sets and evaluation of the plurality of second rectangular regions generated based on the second gene information point set for each of the plurality of second gene information point sets; and dividing the target region based on the plurality of first rectangular regions or the plurality of second rectangular regions generated according to the specified first gene information point set or second gene information point set.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIGS. 1A and 1B depict an example of a divided region generating apparatus according to a first embodiment;

FIG. 2 depicts an example of a system configuration of a second embodiment;

FIG. 3 depicts a configuration example of hardware of a mesh generating apparatus;

FIG. 4 is a block diagram illustrating an example of functions of a mesh generating apparatus;

FIG. 5 depicts an example of information stored in a boundary point list storing unit;

FIG. 6 depicts an example of information stored in an individual information storing unit;

FIG. 7 depicts an example of information stored in a parameter storing unit;

FIG. 8 depicts an example of information stored in a rectangular region storing unit;

FIG. 9 depicts an example of information stored in a hierarchical structured grid storing unit;

FIG. 10 is a flow chart illustrating an example of a procedure of a rectangular region generating process;

FIG. 11 depicts an example of a schematic procedure of evaluating an individual;

FIG. 12 depicts an example of selecting a mesh reference point;

FIG. 13 depicts an example of generating a rectangular region;

FIG. 14 depicts an example of generating a rectangular region of joint box (JB);

FIG. 15 depicts an example of generating rectangular regions of right-side box (RSB) and left-side box (LSB);

FIG. 16 depicts an example of generating a rectangular region of RCB;

FIG. 17 depicts an example of adding a mesh reference point;

FIG. 18 depicts an example of merging rectangular regions;

FIG. 19 depicts an example of optimal solution search based on multi-objective genetic algorithm (GA);

FIG. 20 is a flow chart illustrating an example of a procedure of an individual evaluating process;

FIGS. 21A and 21B are flow charts illustrating an example of a procedure of a rectangular region generating process;

FIGS. 22A and 22B depict an example of a procedure of an evolution process of a population;

FIGS. 23A and 238 depict an example of a procedure of generating an individual as a child;

FIG. 24 is a flow chart illustrating an example of a procedure of a population evolution process based on GA;

FIG. 25 depicts an example of hierarchically generated rectangular regions;

FIG. 26 depicts an example of rotation of an object in an analysis space;

FIG. 27 depicts an example of generating individuals when an object is rotated;

FIG. 28 depicts an example of information of a population according to a third embodiment;

FIGS. 29A and 29B are flow charts illustrating an example of a rectangular region generating process involving rotation of a boundary;

FIG. 30 is a flow chart illustrating an example of a procedure of an evolution process of a population based on GA applying an optimal solution at another rotation angle;

FIG. 31 depicts differences between total areas of rectangular regions depending on whether an optimal solution at another rotation angle is applied;

FIG. 32 depicts an example of reducing total area of rectangular regions based on optimization using GA;

FIGS. 33A and 33B depict differences in convergence depending on whether an optimal solution at another rotation angle is applied; and

FIG. 34 depicts differences between total areas of rectangular regions obtained at same rotation angle depending on whether an optimal solution at another rotation angle is applied.

### DESCRIPTION OF EMBODIMENTS

In view of information included in the Background, an analysis method using the hierarchical structured grid may easily attain high calculation performance of the computer compared to other methods, and the method is considered as an analysis method of next generation.

For example, it is important to generate a high-quality hierarchical structured grid to efficiently perform a highly accurate analysis using the hierarchical structured grid. Conventionally, a user manually generates and inputs the hierarchical structured grid into an analysis space. In generating the hierarchical structured grid, the user sets rectangular regions containing all boundary points and satisfying a large number of conditions at the same time to improve the calculation accuracy and increase the efficiency of calculation. It takes much time for the user to manually input and generate the hierarchical structured grid satisfying various conditions, and the quality of the generated hierarchical structured grid tends to be insufficient.

Various analyses, such as fluid analysis, may be efficiently carried out if an appropriate hierarchical structured grid may be automatically generated. However, there is no technique for automatically generating an appropriate hierarchical structured grid satisfying various conditions. For example, although there is a grid data generating apparatus that may generate grid data as illustrated in Japanese Laid-open Patent Publication No. 2011-134279, the grid data generating apparatus generates an unstructured grid, and an appropriate hierarchical structured grid is not generated.

Note that it is important to sufficiently optimize the mesh in each level to automatically generate an appropriate hierarchical structured grid. If the mesh in each level may be automatically optimized, the levels may be placed on top of each other to generate a high-quality hierarchical structured grid.

The present embodiments will now be described with reference to the drawings. A plurality of embodiments may be combined within a compatible range to carry out each embodiment.

### First Embodiment

In a first embodiment, a hierarchical structured grid used in fluid calculation and the like is optimized by a GA. In a divided region generating method according to the first embodiment, the hierarchical structured grid may be uniquely decided from a distribution of arbitrary points on a space to allow applying the GA. In this way, the GA may be used to optimize the distribution of the arbitrary points on the space to automatically generate an appropriate hierarchical structured grid.

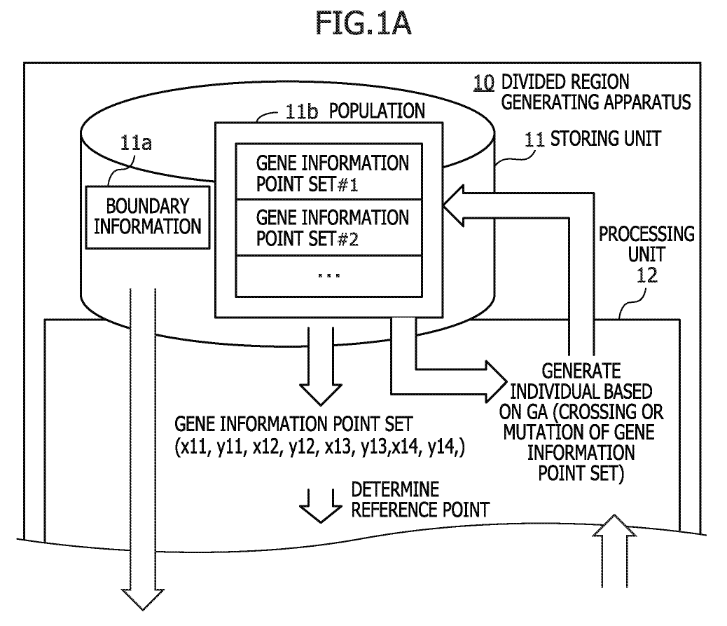

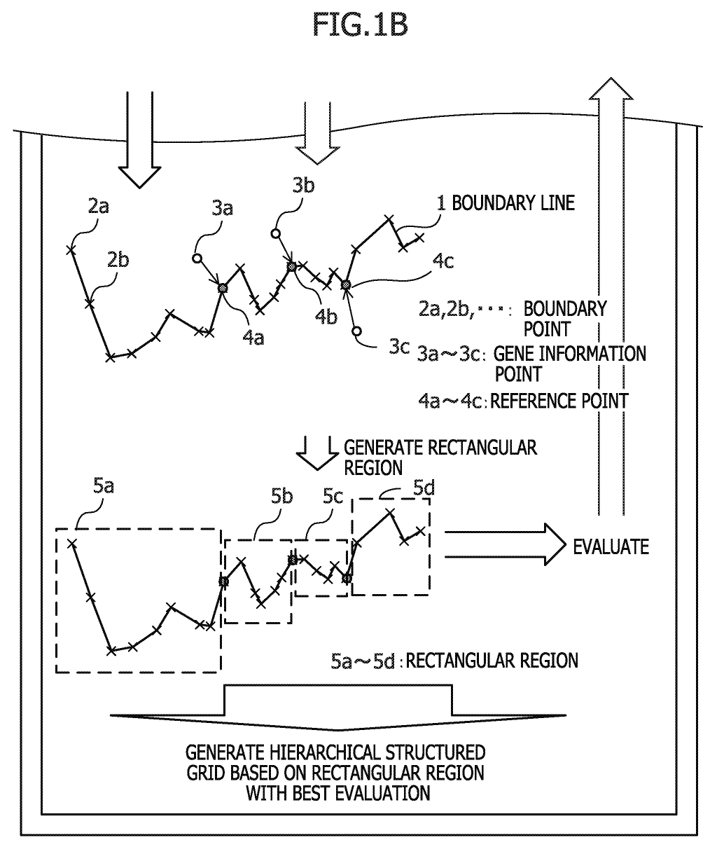

FIGS. 1A and 1B depict an example of a divided region generating apparatus according to the first embodiment. A divided region generating apparatus 10 includes a storing unit 11 and a processing unit 12. The storing unit 11 is, for example, a main memory apparatus or a storage apparatus included in the divided region generating apparatus 10. The processing unit 12 is, for example, a processor or a computing circuit included in the divided region generating apparatus 10. For example, the processor in the divided region generating apparatus 10 executes a divided region generating program to realize the divided region generating method according to the first embodiment.

The storing unit 11 stores boundary information 11a and a population 11b. The boundary information 11a is information indicating a boundary line 1 of a region occupied by an object arranged in a target region and another region on a plane in the target region. The population 11b is information of a plurality of individuals to be evolved by the GA. Each individual is expressed by a gene information point set. The gene information point set is a set of gene information points 3a to 3c.

The processing unit 12 generates the hierarchical structured grid in the following procedure based on the boundary information 11a.

The processing unit 12 first refers to the boundary information 11a to generate a plurality of gene information point sets (first gene information point sets) of a first generation in the GA. Each of the plurality of gene information point sets includes a plurality of gene information points (first gene information points), and the number of gene information points corresponds to a first set value related to a degree of division of the target region. For example, the processing unit 12 randomly generates points on a plane in the target region, in which the number of points corresponds to the first set value. The processing unit 12 generates a gene information point set including the generated points as gene information points. The processing unit 12 regards the plurality of generated gene information point sets of the first generation as the population 11b and stores the sets in the storing unit 11.

Next, the processing unit 12 extracts gene information point sets not evaluated included in the population 11b from the storing unit 11. The population 11b includes only the gene information point sets of the first generation before generation of individuals of the next generation based on the GA, and the gene information point sets of the first generation are extracted.

For each of the extracted gene information point sets of the first generation, the processing unit 12 decides a plurality of reference points 4a to 4c (first reference points) on the boundary line 1 based on the plurality of gene information points 3a to 3c included in the gene information point set. For example, the processing unit 12 decides that boundary points closest to the first gene information points among a plurality of boundary points 2a, 2b and . . . set in advance on the boundary line 1 are the reference points 4a to 4c corresponding to the first gene information points. The plurality of boundary points 2a, 2b and . . . are indicated by x-marks on the boundary line 1.

Next, the processing unit 12 generates rectangular regions 5a to 5d (first rectangular regions) for each of the plurality of gene information point sets of the first generation. In the rectangular regions 5a to 5d, a side including one of the plurality of reference points and a side not including any of the plurality of reference points form a rectangular shape. The side of the rectangular regions 5a to 5d not including any of the plurality of reference points and the boundary line 1 are separated by a second set value indicating the distance to the boundary line 1.

For each of the plurality of gene information point sets of the first generation, the processing unit 12 evaluates the plurality of rectangular regions 5a to 5d generated based on the gene information point set. For example, the processing unit 12 calculates an evaluation value of the gene information point set by using an evaluation formula of a process in which the number of rectangular regions 5a to 5d, the area of the rectangular regions 5a to 5d, and the like are variables.

This completes the process related to the plurality of gene information point sets of the first generation.

Next, the processing unit 12 uses the GA to generate gene information point sets (second information point sets) of a second generation based on the plurality of gene information point sets included in the population 11b. For example, the processing unit 12 selects a given number of gene information point sets (selected first gene information point sets) from the plurality of gene information point sets of the first generation included in the population 11b. For example, the processing unit 12 randomly selects two gene information point sets from the plurality of gene information point sets of the first generation. The processing unit 12 may also increase selection probabilities of highly evaluated gene information point sets among the plurality of gene information point sets of the first generation and select two gene information point sets at random.

Based on the selected gene information point sets, the processing unit 12 uses the genetic algorithm to generate a plurality of gene information point sets of the second generation. Each of the plurality of gene information point sets includes a plurality of gene information points (second gene information points), and the number of gene information points corresponds to the first set value. A process of crossing or mutating the gene information point sets is executed by the genetic algorithm in generating the plurality of gene information point sets of the second generation.

For each of the plurality of gene information point sets of the second generation, the processing unit 12 decides a plurality of reference points (second reference points) on the boundary line 1 based on the plurality of gene information points included in the gene information point set. Next, the processing unit 12 generates a plurality of rectangular regions 5a to 5d (second rectangular regions) for each of the plurality of gene information point sets of the second generation. For each of the plurality of gene information point sets of the second generation, the processing unit 12 evaluates the plurality of rectangular regions 5a to 5d generated based on the gene information point set.

The processing unit 12 selects part of the plurality of gene information point sets of the second generation based on the evaluation result. For example, the processing unit 12 selects the gene information point set with the highest evaluation. The processing unit 12 also sets a higher selection probability for higher evaluation and selects one or a plurality of gene information point sets at random. The processing unit 12 includes the selected gene information point sets in the population 11b.

This completes the process related to the plurality of gene information point sets of the second generation. Subsequently, as in the case of the second generation, a plurality of gene information point sets of each of third and subsequent generations are generated based on the gene information point sets included in the population 11b, and some gene information point sets selected from the plurality of gene information point sets are added to the population 11b. For example, the processing unit 12 repeats the generating process of the gene information point sets of the next generation based on the GA for a number of times equivalent to the number of generations designated in advance.

Once the generation of the gene information point sets based on the GA is finished, the processing unit 12 specifies one of the plurality of gene information point sets as an optimal solution based on the evaluation of each of the gene information point sets included in the population 11b. The processing unit 12 then divides the target region based on the plurality of rectangular regions 5a to 5d generated according to the gene information point set as the optimal solution.

In this way, the GA may be used to automatically generate a plurality of appropriate rectangular regions 5a to 5d. For example, the plurality of rectangular regions 5a to 5d may be uniquely decided from the plurality of gene information point sets. Therefore, only the gene information point sets may be the target of operation, such as crossing, using the GA. Moreover, the conditions for generating the plurality of rectangular regions 5a to 5d are not included in the operation of the GA regarding the gene information. As a result, the next generation may be easily generated based on the GA. When the GA may be effectively used, it may be easy to efficiently find out a highly evaluated gene information point, and the automatic generation of a plurality of appropriate rectangular regions 5a to 5d may be desirably executed.

The plurality of rectangular regions 5a to 5d may be used as a mesh of one level of a hierarchical structured grid. A plurality of similar rectangular regions 5a to 5d may be generated for a plurality of levels with different resolutions, and the mesh of each level in the hierarchical structured grid may be generated. In this way, a high-quality hierarchical structured grid is generated.

In generating the plurality of rectangular regions 5a to 5d, the processing unit 12 generates the rectangular regions 5b and 5c including the reference points on two opposing sides when, for example, the following two conditions are satisfied. A first condition is that when a plurality of reference points are arranged based on coordinate value of a first axis (for example, x -axis) of one plane, the difference in coordinate value of a second axis (for example, y-axis) perpendicular to the first axis between two reference points adjacent to each other is equal to or smaller than a given value. A second condition is that for all of the boundary points set between two reference points in the boundary line 1, the difference in coordinate value of the second axis between the boundary point and another adjacent boundary point is equal to or smaller than a given value. When the two conditions are satisfied, the processing unit 12 generates the rectangular regions 5b and 5c including the two first reference points and all of the boundary points set between two reference points on the boundary line 1.

In generating the plurality of rectangular regions 5a to 5d, the processing unit 12 may generate the rectangular regions 5a and 5d including the reference point on only one side. For example, the processing unit 12 regards one of the plurality of reference points as a starting point. The processing unit 12 then sets the boundary points as search targets in ascending order of distance from the reference point as the starting point based on coordinate value of the first axis and performs a search in a positive or negative direction of the first axis from the reference point as the starting point. The processing unit 12 compares the coordinate value of the second axis of the reference point as the starting point and the coordinate value of the second axis of the boundary point as the search target and compares all of the coordinate values of the second axis of the other boundary points between the reference point as the starting point and the boundary point as the search target and the coordinate value of the second axis of the boundary point as the search target. The processing unit 12 generates the rectangular regions 5a and 5d including the reference point as the starting point as well as the other boundary points between the reference point as the starting point and the boundary point as the search target when the differences between the coordinate value of the second axis of the boundary point as the search start and all of the compared coordinate values are greater than a given value. The rectangular regions 5a and 5d do not include the lastly searched boundary point.

There may be boundary points not included in any of the rectangular regions 5a to 5d even when the generation of the rectangular regions 5a to 5d based on the reference point corresponding to the gene information points is completed. In that case, the processing unit 12 regards one of the boundary points not included in any of the rectangular regions 5a to 5d as an additional reference point and generates a new rectangular region based on the additional reference point. In this way, a plurality of rectangular regions may be generated so that all of the boundary points are included in one of the rectangular regions. For example, even when the value of the first set value is too small or the position of the gene information point is deviated, the reference point may be compensated to generate an appropriate rectangular region adapted for the generation conditions of the rectangular region (all of the reference points are included in one of the rectangular regions).

The processing unit 12 may further merge two rectangular regions sharing one first reference point into one rectangular region when the deviation in the parallel direction between sides including the shared reference point is equal to or smaller than a given value in the two rectangular regions. For example, the processing unit 12 determines that the deviation is equal to or smaller than the given value if the difference (distance) between end points of the sides including the shared reference point is equal to or smaller than the given value at both ends in the two rectangular regions. In this way, adjacent rectangular regions with a small deviation may be merged to reduce the number of rectangular regions. When the number of rectangular regions is small, the number of meshes of the hierarchical structured grid generated based on the rectangular regions is also small. Therefore, an analysis process using the hierarchical structured grid may be efficiently executed.

In creating the hierarchical structured grid, the processing unit 12 hierarchically generates the rectangular regions, for example. The processing unit 12 may, for example, use the method illustrated in FIGS. 1A and 1B to create the innermost rectangular region and then use a similar method to create a rectangular region outside of the innermost rectangular region. For example, the processing unit 12 generates an outer rectangular region containing one or a plurality of rectangular regions among the plurality of rectangular regions (inner rectangular regions) generated according to the gene information point set specified as the optimal solution. In that case, for example, the processing unit 12 sets a side of the inner rectangular region as the boundary line 1 and sets a corner of the inner rectangular region as the boundary point to generate the outer rectangular region based on the method illustrated in FIGS. 1A and 1B.

The boundary line 1 may be rotated depending on the analysis using the hierarchical structured grid based on the generated rectangular regions. If the boundary line 1 may be rotated, the rectangular regions may be generated according to each arrangement of the boundary line 1 at various angles to obtain more highly evaluated gene information point sets.

Therefore, when the rotation of the boundary line 1 is permitted, the processing unit 12 rotates the boundary line 1 by a given angle at a time in a plane, for example. The processing unit 12 then executes the process illustrated in FIGS. 1A and 1B every time the boundary line 1 is rotated. In this way, more highly evaluated rectangular regions may be generated.

When the boundary line 1 is rotated for a plurality of times by a small angle at a time, the optimal solution at the previous rotation angle may also be applied to the GA at the next rotation angle. For example, in the generating process of the second gene information point sets after the rotation of the boundary line 1 from a first rotation angle to a second rotation angle, the optimal solution at the first rotation angle may be applied to the GA at the second rotation angle. In this case, the processing unit 12 puts the gene information point sets selected based on the evaluation values from the plurality of gene information point sets generated at the first rotation angle into the gene information point sets after the rotation to the second rotation angle (for example, gene information point sets generated for the second generation). In this way, by applying the optimal solution at another rotation angle, the evaluation of the rectangular regions generated at each rotation angle may be improved, and favorably evaluated rectangular regions may be efficiently generated.

Accordingly, the processing unit 12 of the divided region generating apparatus 10 generates the plurality of first gene information point sets. The processing unit 12 then decides the plurality of first reference points on the boundary line 1 and generates the plurality of first rectangular regions 5a to 5d for each of the plurality of first gene information point sets. The processing unit 12 uses the genetic algorithm to generate the plurality of second gene information point sets. The processing unit 12 decides the plurality of second reference points on the boundary line 1 and generates the plurality of second rectangular regions for each of the plurality of second gene information point sets. The processing unit 12 specifies one of the plurality of first gene information point sets and the plurality of second gene information point sets. The processing unit 12 divides the target region based on the plurality of first rectangular regions or the plurality of second rectangular regions generated according to the specified first gene information point set or second gene information point set.

### Second Embodiment

Next, a second embodiment will be described. A second embodiment provides a system that uses an automatically generated hierarchical structured grid to analyze the movement of a fluid around a three-dimensional model.

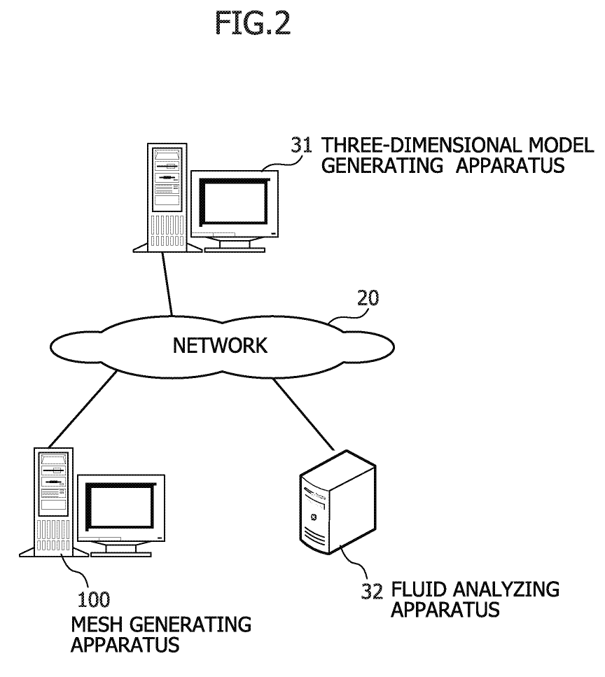

FIG. 2 depicts an example of a system configuration of the second embodiment. In the system illustrated in FIG. 2, a three-dimensional model generating apparatus 31, a mesh generating apparatus 100, and a fluid analyzing apparatus 32 are coupled through a network 20. The three -dimensional model generating apparatus 31 generates a three-dimensional model representing an automobile, an airplane, or the like arranged in an analysis space. The mesh generating apparatus 100 acquires a boundary point list indicating the shape of the surface of the three-dimensional model from the three-dimensional model generating apparatus 31 and generates a hierarchical structured grid based on the boundary point list. The fluid analyzing apparatus 32 executes a fluid simulation based on the three-dimensional model generated by the three-dimensional model generating apparatus 31 and the hierarchical structured grid generated by the mesh generating apparatus 100 to analyze the temporal variation in the physical quantity of the fluid around the three -dimensional model.

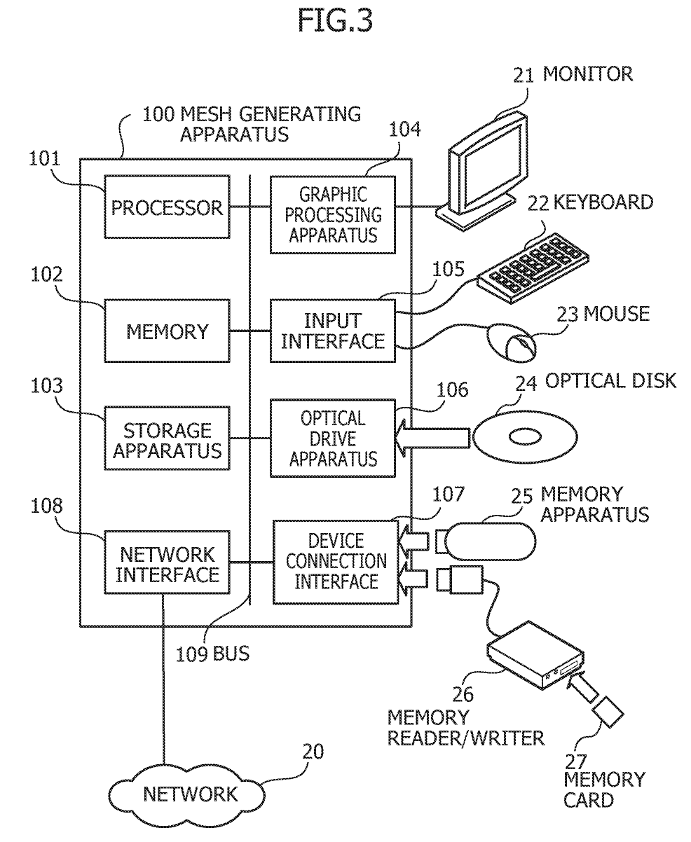

FIG. 3 depicts a configuration example of hardware of the mesh generating apparatus. A processor 101 controls the entire mesh generating apparatus 100. A main memory apparatus 102 and a plurality of peripheral devices are coupled to the processor 101 through a bus 109. The processor 101 may be a multiprocessor. The processor 101 is, for example, a central processing unit (CPU), a micro processing unit (MPU), or a digital signal processor (DSP). At least part of functions realized by the processor 101 executing a program may be realized by an electronic circuit, such as an application specific integrated circuit (ASIC) and a programmable logic device (PLD).

The main memory apparatus 102 is used as a main storage apparatus of the mesh generating apparatus 100. At least part of programs of an operating system (OS) and application programs to be executed by the processor 101 is temporarily stored in the main memory apparatus 102. Various types of data for processing by the processor 101 are also stored in the main memory apparatus 102. A volatile semiconductor storage apparatus, such as a random access memory (RAM), is used for the main memory apparatus 102.

Examples of the peripheral devices coupled to the bus 109 include a storage apparatus 103, a graphic processing apparatus 104, an input interface 105, an optical drive apparatus 106, a device connection interface 107, and a network interface 108.

The storage apparatus 103 electrically or magnetically writes and reads data to and from a built-in recording medium. The storage apparatus 103 is used as an auxiliary storage apparatus of a computer. The programs of the OS, the application programs, and various types of data are stored in the storage apparatus 103. Examples of the storage apparatus 103 that may be used include a hard disk drive (HDD) and an solid state drive (SSD). The storage apparatus 103 and the main memory apparatus 102 will be referred to as memories in some cases.

A monitor 21 is coupled to the graphic processing apparatus 104. The graphic processing apparatus 104 displays an image on a screen of the monitor 21 according to a command from the processor 101. Examples of the monitor 21 include a display apparatus using a cathode ray tube (CRT) and a liquid crystal display apparatus.

A keyboard 22 and a mouse 23 are coupled to the input interface 105. The input interface 105 transmits a signal transmitted from the keyboard 22 or the mouse 23 to the processor 101. The mouse 23 is an example of a pointing device, and other pointing devices may also be used. Examples of the other pointing devices include a touch panel, a tablet, a touchpad, and a trackball.

The optical drive apparatus 106 uses laser light or the like to read data recorded in an optical disk 24. The optical disk 24 is a portable recording medium recording data such that the data may be read by reflection of light. Examples of the optical disk 24 include a digital versatile disc (DVD), a DVD -RAM, a compact disc read only memory (CD-ROM), and a CD-recordable (R)/rewritable (RW).

The device connection interface 107 is a communication interface for coupling peripheral devices to the mesh generating apparatus 100. For example, a memory apparatus 25 and a memory reader/writer 26 may be coupled to the device connection interface 107. The memory apparatus 25 is a recording medium including a function of communicating with the device connection interface 107. The memory reader/writer 26 is an apparatus that writes data to a memory card 27 or reads data from the memory card 27. The memory card 27 is a card-type recording medium.

The network interface 108 is coupled to the network. 20. The network interface 108 transmits and receives data to and from another computer or a communication device through the network 20.

The hardware configuration as described above may realize the processing function of the second embodiment. The divided region generating apparatus 10 illustrated in the first embodiment may also be realized by hardware similar to the mesh generating apparatus 100 illustrated in FIG. 3.

The mesh generating apparatus 100 executes, for example, a divided region generating program recorded in a computer-readable recording medium to realize the processing function of the second embodiment.

Programs describing the processes to be executed by the mesh generating apparatus 100 may be recorded in various recording media. For example, the programs to be executed by the mesh generating apparatus 100 may be stored in the storage apparatus 103. The processor 101 loads at least part of the programs in the storage apparatus 103 to the main memory apparatus 102 to execute the programs. The programs to be executed by the mesh generating apparatus 100 may also be recorded in a portable recording medium, such as the optical disk 24, the memory apparatus 25, and the memory card 27. The programs stored in the portable recording medium may be executed after installing the programs on the storage apparatus 103 based on, for example, the control by the processor 101. The processor 101 may also directly read the programs from the portable recording medium to execute the programs.

Next, functions of the mesh generating apparatus 100 for generating the hierarchical structure grid will be described.

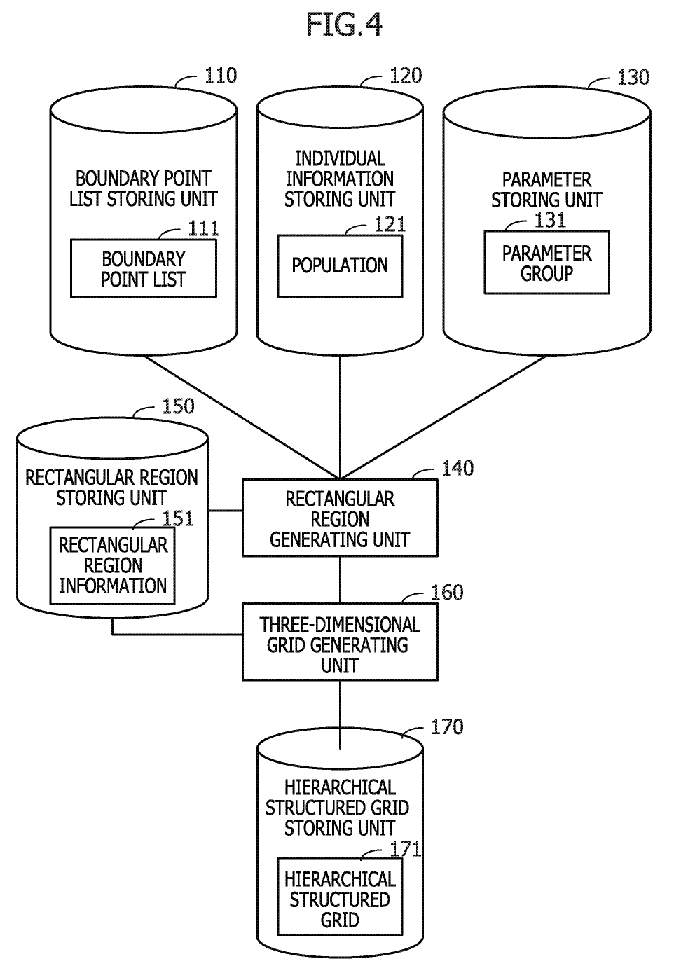

FIG. 4 is a block diagram illustrating an example of the functions of a mesh generating apparatus. The mesh generating apparatus 100 includes a boundary point list storing unit 110, an individual information storing unit 120, a parameter storing unit 130, a rectangular region generating unit 140, a rectangular region storing unit 150, a three-dimensional grid generating unit 160, and a hierarchical structured grid storing unit 170.

The boundary point list storing unit 110 stores a boundary point list 111. The boundary point list 111 is a list of a plurality of boundary points on a boundary surface between the region occupied by the three-dimensional model generated by the three-dimensional model generating apparatus 31 and a region occupied by the fluid around the three-dimensional model. For example, part of the storage area of the main memory apparatus 102 or the storage apparatus 103 is used as the boundary point list storing unit 110.

The individual information storing unit 120 stores a population 121 generated by the rectangular region generating unit 140. The population 121 is information of a plurality of individuals. Each individual includes a plurality of gene information points (gene information point sets). A plurality of rectangular regions are uniquely decided based on the gene information point sets. For example, part of the storage area of the main memory apparatus 102 or the storage apparatus 103 is used as the individual information storing unit 120.

The parameter storing unit 130 stores a parameter group 131 used to generate the hierarchical structured grid. The parameter group 131 is input by, for example, the user using the keyboard 22 or the like. For example, part of the storage area of the main memory apparatus 102 or the storage apparatus 103 is used as the parameter storing unit 130.

The rectangular region generating unit 140 uses the information stored in the boundary point list storing unit 110, the individual information storing unit 120, and the parameter storing unit 130 to generate two -dimensional rectangular regions. The rectangular region generating unit 140 stores information of the generated rectangular regions in the rectangular region storing unit 150. The rectangular region generating unit 140 also regards the information indicating the individual determined to have the highest evaluation in the end as an optimal solution and outputs the optimal solution to the three -dimensional grid generating unit 160.

The three-dimensional grid generating unit 160 generates a three- dimensional hierarchical structured grid 171 based on the rectangular regions of the individual as the optimal solution. For example, the three-dimensional grid generating unit 160 extends the rectangular regions set on a two-dimensional plane in the perpendicular direction of the plane to form three-dimensional regions. The three-dimensional extension changes the rectangles into hexahedrons. The three-dimensional grid generating unit 160 then divides the hexahedrons into a plurality of elements by using a plurality of planes perpendicular to the axis of the direction of extension as boundaries. The three-dimensional grid generating unit 160 uses, for example, a plurality of planes at regular intervals to divide the hexahedrons. The three-dimensional grid generating unit 160 stores the generated hierarchical structured grid 171 in the hierarchical structured grid storing unit 170.

The rectangular region storing unit 150 stores rectangular region information 151. The rectangular region information 151 is information of the rectangular regions generated according to each individual included in the population 121. For example, part of the storage area of the main memory apparatus 102 or the storage apparatus 103 is used as the rectangular region storing unit 150.

The hierarchical structured grid storing unit 170 stores the hierarchical structured grid 171. The hierarchical structured grid 171 is obtained by three-dimensionally expanding the rectangular regions for the most highly evaluated individual. For example, part of the storage area of the main memory apparatus 102 or the storage apparatus 103 is used as the hierarchical structured grid storing unit 170.

Note that the function of each element illustrated in FIG. 4 may be realized by, for example, causing the computer to execute a program module corresponding to the element.

Next, the information stored in each storing unit will be described in detail.

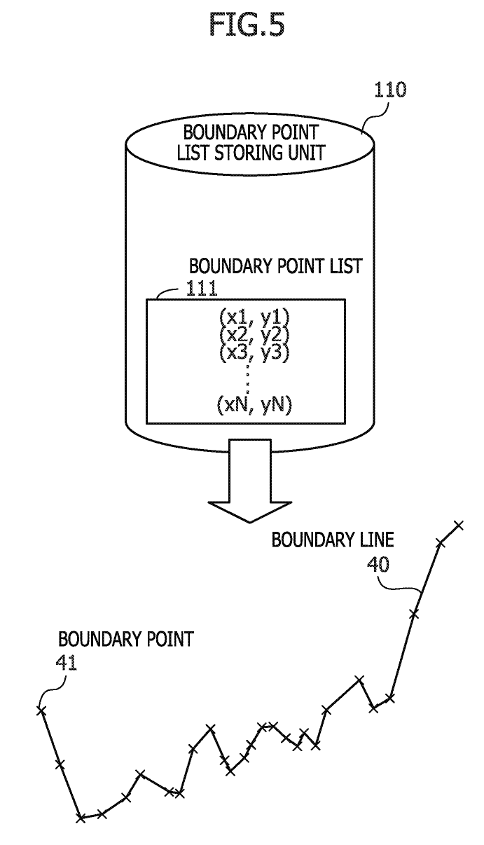

FIG. 5 depicts an example of the information stored in the boundary point list storing unit. The coordinates of each of a plurality of boundary points 41 on a boundary line 40 of the three-dimensional model and the fluid on a given plane in the analysis space are set in the boundary point list 111 stored in the boundary point list storing unit 110. The boundary line 40 is, for example, a line on a plane (horizontal plane) perpendicular to the gravity direction.

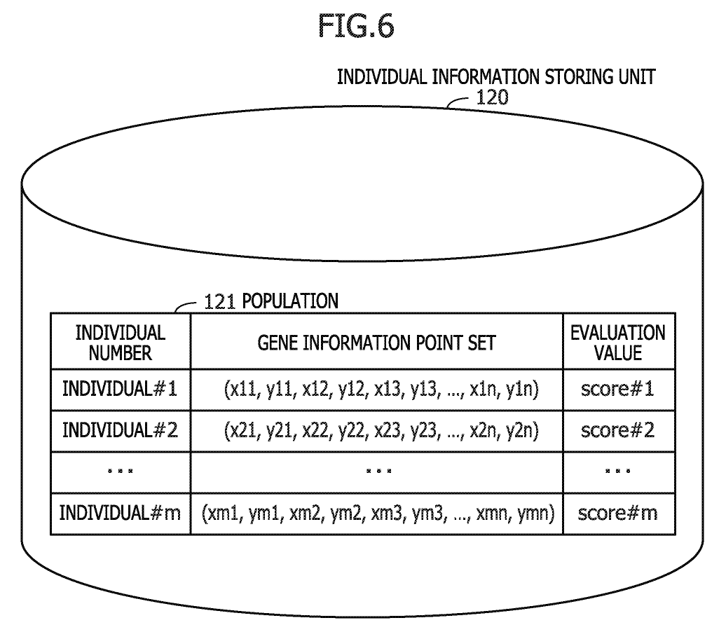

FIG. 6 depicts an example of the information stored in the individual information storing unit. For example, the information of each individual is indicated in one record for the population 121 stored in the individual information storing unit 120. Each record includes, for example, an individual number, a gene information point set, and an evaluation value. The individual number is an identification number of the individual. The gene information point set provides the coordinates of each of the plurality of gene information points indicating features of the individual. The evaluation value is an evaluation value of the rectangular regions generated based on the individual.

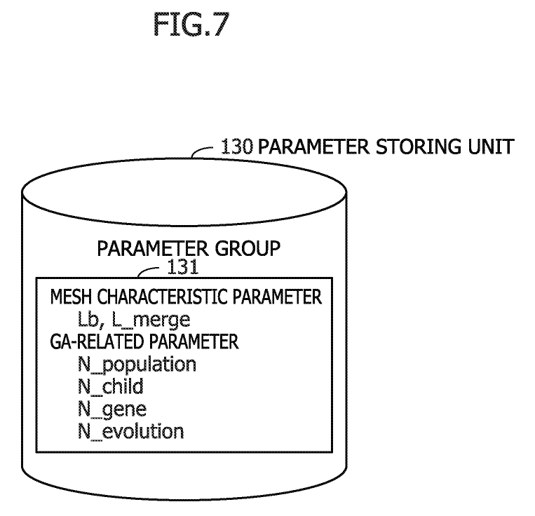

FIG. 7 depicts an example of the information stored in the parameter storing unit. Parameters included in the parameter group 131 stored in the parameter storing unit 130 are classified into mesh characteristic parameters and GA-related parameters. The mesh characteristic parameters include “Lb” and “L_merge.” The “Lb” is a distance from the boundary point to the end of the rectangular region. The “L-merge” is a threshold as a standard for determining whether to merge adjacent rectangular regions. The GA-related parameters include “N_population,”“N_child,”“N_gene,” and “N_evolution.” The “N_population” indicates the number of individuals included in the population to be generated first. The “N_child” indicates the number of children created by crossing. The “N_gene” indicates the number of gene information points included in the individual. The “N_evolution” indicates the maximum number of repetitions of loop processing for optimization.

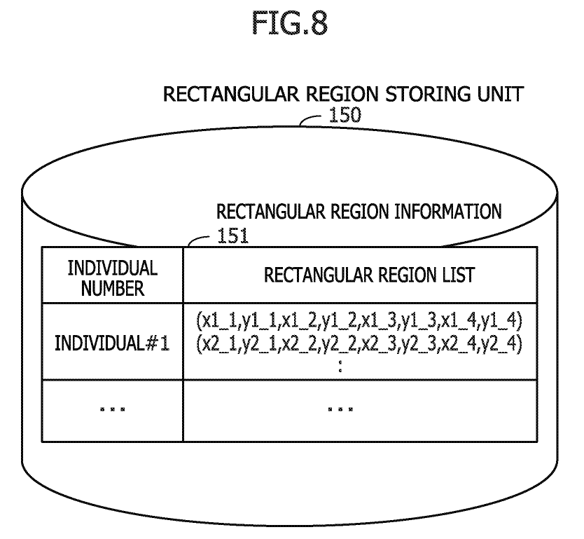

FIG. 8 depicts an example of the information stored in the rectangular region storing unit. For example, information of a plurality of rectangular regions generated according to each individual is indicated in one record of the rectangular region information 151 stored in the rectangular region storing unit 150. Each record includes an individual number and a rectangular region list. The rectangular region list indicates, for example, the coordinates of four vertices of each of the plurality of rectangular regions.

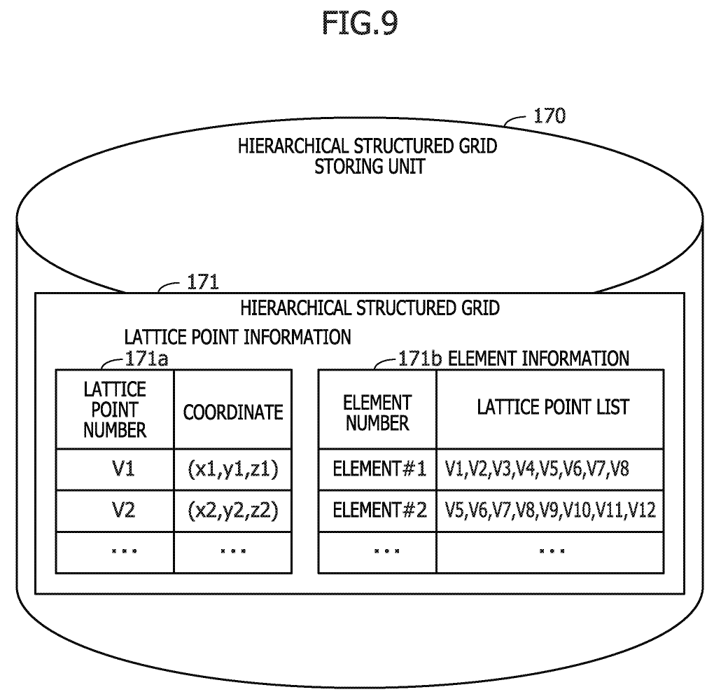

FIG. 9 depicts an example of the information stored in the hierarchical structured grid storing unit. The hierarchical structured grid 171 stored in the hierarchical structured grid storing unit 170 includes, for example, lattice point information 171a indicating positions of lattice points of the hierarchical structured grid and element information 171b indicating elements of the hexahedrons of the hierarchical structured grid. The coordinates of each lattice point in the three-dimensional space are set in the lattice point information 171a in association with the lattice point number indicating the lattice point. A lattice point list indicating a plurality of lattice points at the vertices of each element is set in the element information 171b in association with the element number indicating the element. The lattice point list includes a plurality of lattice point numbers.

Next, the generating process of the rectangular regions in the rectangular region generating unit 140 will be described in detail.

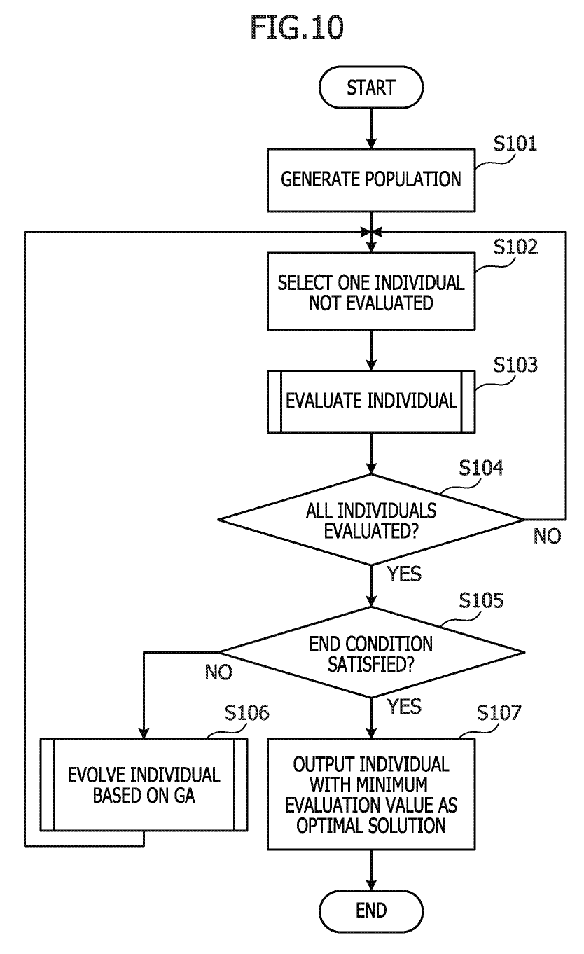

FIG. 10 is a flow chart illustrating an example of a procedure of the rectangular region generating process. The process illustrated in FIG. 10 will be described with reference to the step numbers.

[Step S101]

The rectangular region generating unit 140 generates an initial population 121. For example, the rectangular region generating unit 140 refers to the parameter storing unit 130 and generates individuals. The number of individuals is indicated by the “N_population.” In generating each individual, the rectangular region generating unit 140 generates “N_gene” gene information points, in which the “N_gene” indicates the features of the individual. The rectangular region generating unit 140 randomly sets the positions of the generated gene information points. The rectangular region generating unit 140 stores the plurality of generated individuals as the population 121 in the individual information storing unit 120. At this point, the evaluation value of each individual of the population 121 stored in the individual information storing unit 120 is not set (blank).

[Step S102] The rectangular region generating unit 140 selects one individual not evaluated from the population 121. The individual not evaluated is an individual in which the evaluation value is not set in the individual information storing unit 120.

[Step S103]

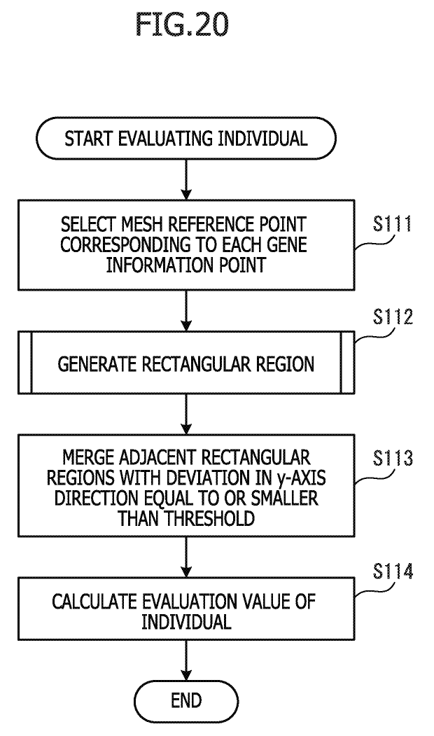

The rectangular region generating unit 140 applies an individual evaluating process to the selected individual. The details of the individual evaluating process will be described later (see FIG. 20). In the second embodiment, the smaller the individual value calculated in the individual evaluating process, the higher the evaluation.

[Step S104]

The rectangular region generating unit 140 determines whether all of the individuals are evaluated. For example, the rectangular region generating unit 140 determines that all of the individuals are evaluated when the evaluation values are set for all of the individuals in the individual information storing unit 120. The rectangular region generating unit 140 advances the process to step S105 when all of the individuals are evaluated. The rectangular region generating unit 140 advances the process to step S102 when there is an individual not evaluated.

[Step S105]

The rectangular region generating unit 140 determines whether an end condition of generating the rectangular region is satisfied. The end condition is, for example, that an individual with the evaluation value smaller than a threshold has emerged or that the number of evolutions based on the GA has exceeded the limit value “N_evolution.” The rectangular region generating unit 140 advances the process to step S107 when the end condition is satisfied. The rectangular region generating unit 140 advances the process to step S106 if the end condition is not satisfied.

[Step S106]

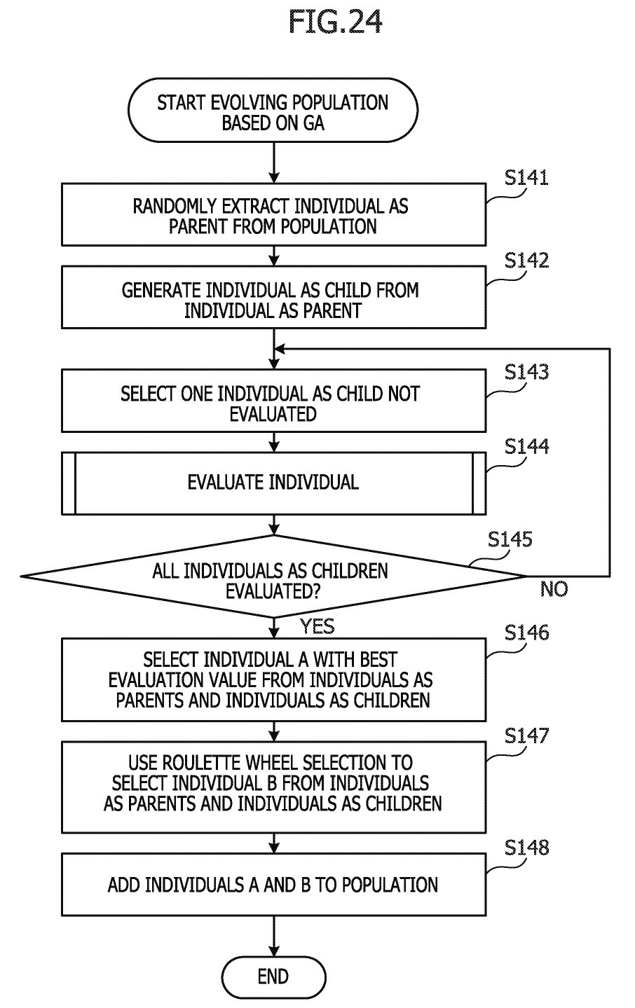

The rectangular region generating unit 140 executes an evolution process of the population 121 based on the GA. The details of the process will be described later (see FIG. 24). As a result of the evolution process of the population, the individuals generated by the operation of the GA, such as selection, crossing, and mutation, are added to the population 121. Therefore, the rectangular region generating unit 140 advances the process to step S102 to evaluate the new individuals.

Note that when the generated individuals as children are evaluated in the course of the evolution of the population 121, the individuals may not be evaluated again in step S103 if the evaluation values are stored. In that case, the rectangular region generating unit 140 advances the process to step S105 after the end of step S106.

[Step S107]

The rectangular region generating unit 140 regards the individual with the minimum evaluation value among the individuals included in the population 121 as an optimal solution and outputs the optimal solution. For example, the rectangular region generating unit 140 transmits the individual number of the individual with the minimum evaluation value to the three -dimensional grid generating unit 160.

In this way, the individual as the optimal solution is specified. The three-dimensional grid generating unit 160 then generates the three-dimensional hierarchical structured grid based on the rectangular regions corresponding to the individual as the optimal solution.

The details of the procedure of evaluating the individual will be described.

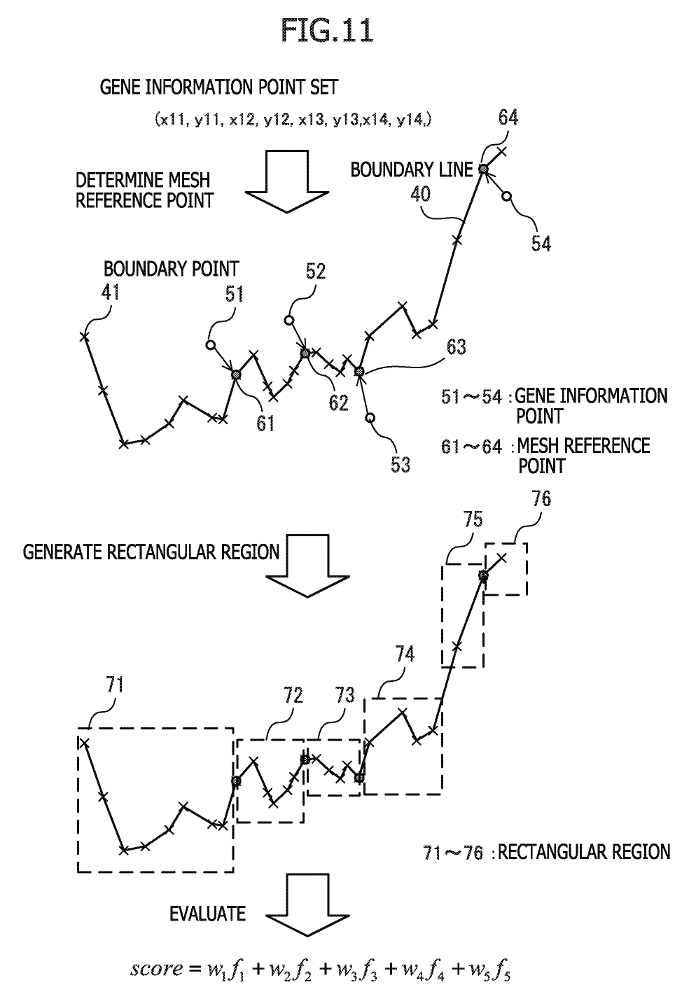

FIG. 11 depicts an example of a schematic procedure of evaluating the individual. In the example of FIG. 11, the coordinates of four gene information points 51 to 54 are illustrated in the gene information point set of the individual. For each of the gene information points 51 to 54, the rectangular region generating unit 140 extracts a closest boundary point among a plurality of boundary points 41. The rectangular region generating unit 140 then sets the extracted boundary points as mesh reference points 61 to 64.

The rectangular region generating unit 140 generates a plurality of rectangular regions 71 to 76 such that the mesh reference point is at the right end or the left end of the rectangular region. The rectangular region generating unit 140 uses an evaluation function to evaluate the generated rectangular regions and obtains evaluation values. An evaluation function using a plurality of indices may be used as the evaluation function. Examples of the indices that may be used include the area of the rectangular region, the number of rectangular regions, and the length of the time step in a simulation according to the size of the rectangular region. For example, the values of the indices may be multiplied by weights, and the sum of the values may be set as the evaluation value (score). Each individual may be evaluated by the evaluation value, and an individual with a small evaluation value (high evaluation) may be extracted to realize multi-objective optimization.

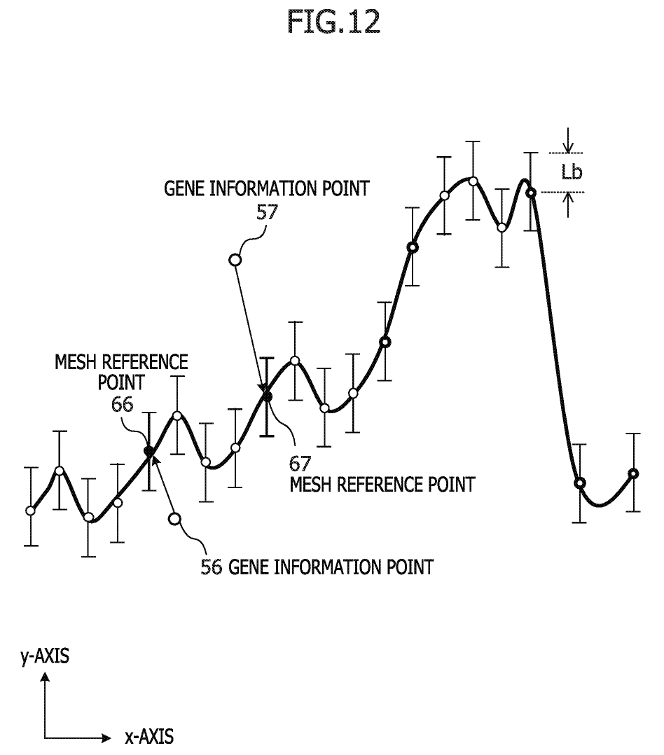

A procedure of generating an individual value evaluation rectangular region will be described with reference to FIGS. 12 to 19.

FIG. 12 depicts an example of selecting the mesh reference points. It is assumed that “N_gene” is “2” in the example of FIG. 12. In this case, two gene information points 56 and 57 are generated at random positions in association with one individual. Boundary points closest to the two gene information points 56 and 57 are selected as mesh reference points 66 and 67, respectively.

In the example of FIG. 12, the horizonal axis is the x-axis, and the vertical axis is the y-axis. The boundary point is indicated by a circle, and the length “Lb” above and below the boundary point is expressed by a line segment passing through the boundary point.

The rectangular regions are generated based on the selected mesh reference points 66 and 67.

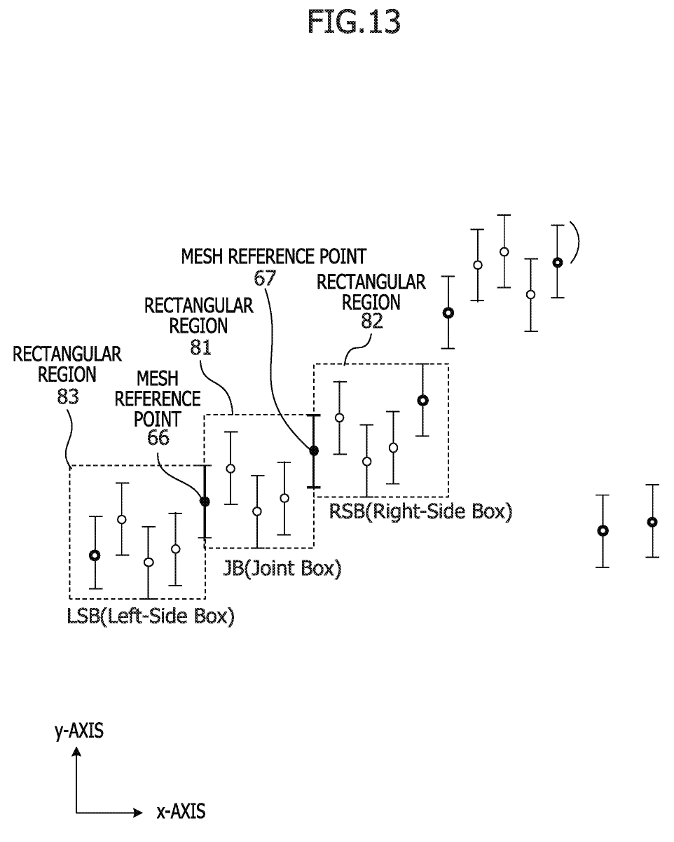

FIG. 13 depicts an example of generating the rectangular regions. In the example of FIG. 13, three rectangular regions 81 to 83 are generated.

Among the rectangular regions 81 to 83 illustrated in FIG. 13, other rectangular regions 82 and 83 exist on the left and right sides of the rectangular region 81, adjacent to the rectangular region 81. The rectangular region 81 will be referred to as, for example, a JB. Only another rectangular region 81 exists on the left side of the rectangular region 82, adjacent to the rectangular region 82 (right end in the alignment of adjacent rectangular regions). The rectangular region 82 will be referred to as, for example, an RSB. Only another rectangular region 81 exists on the right side of the rectangular region 83, adjacent to the rectangular region 83 (left end in the alignment of adjacent rectangular regions). The rectangular region 83 will be referred to as, for example, an LSB.

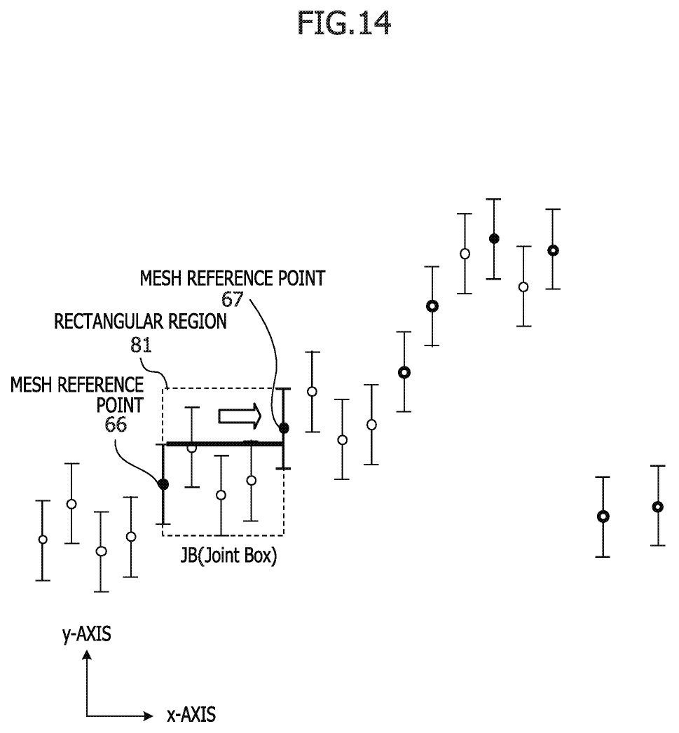

FIG. 14 depicts an example of generating the rectangular region of the JB. In the case of the rectangular region 81 of the JB, the section is searched to the right from the mesh reference point 66, and the adjacent mesh reference point 67 is searched. Whether the difference in the vertical direction between the mesh reference point 66 and the mesh reference point 67 is equal to or smaller than “Lb×2” is determined, and whether the difference in the vertical direction between the boundary point and the adjacent boundary point is equal to or smaller than “Lb×2” for all of the boundary points between the mesh reference point 66 and the mesh reference point 67 is determined. This condition is satisfied in the example of FIG. 14. When the condition is satisfied, the rectangular region 81 including all of the boundary points from the mesh reference point 66 to the mesh reference point 67 is generated. For example, the rectangular region 81 is generated by setting the mesh reference point 66 as the left end and setting the mesh reference point 67 as the right end. The upper end of the rectangular region 81 is at the position where “Lb” is added to the y coordinate value of the uppermost point among the mesh reference points 66 and 67 and the boundary points in the rectangular region 81. The lower end of the rectangular region 81 is at the position where “Lb” is subtracted from the y coordinate value of the lowermost point among the mesh reference points 66 and 67 and the boundary points in the rectangular region 81.

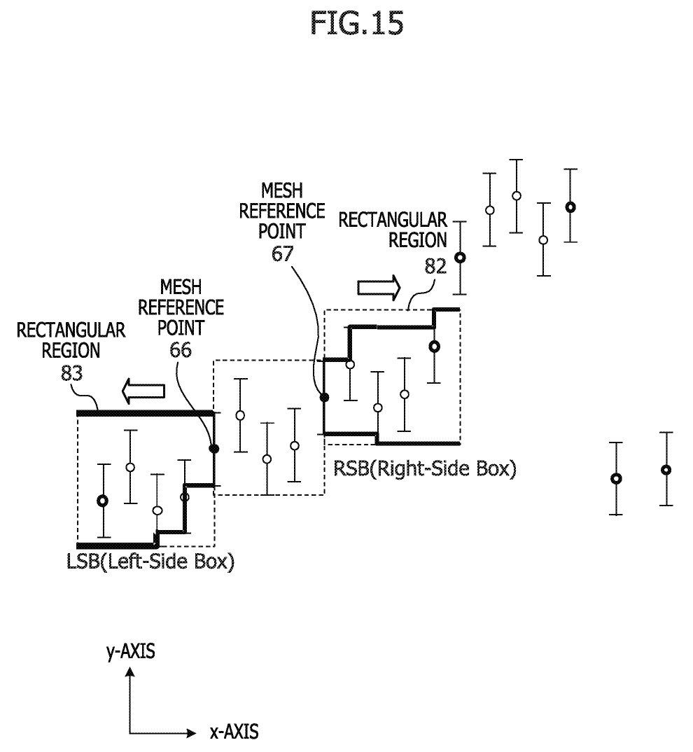

FIG. 15 depicts an example of generating the rectangular regions of the RSB and the LSB. In the case of the rectangular region 82 of the RSB, the boundary points are sequentially searched to the right from the mesh reference point 67. In the search, whether a condition that the difference in the vertical direction between the boundary point as the search target and one of the other boundary points already searched is equal to or smaller than “Lb×2” is satisfied is determined. In the example of FIG. 15, a boundary point not satisfying the condition is detected prior to the other mesh reference points, and the rectangular region 82 including each boundary point satisfying the condition is generated. The left end of the rectangular region 82 is the mesh reference point 67. The right end of the rectangular region 82 is at the position where “Lb” is added to the x coordinate value of the rightmost boundary point in the rectangular region 82. The upper end of the rectangular region 82 is at the position where “Lb” is added to the y coordinate value of the uppermost point among the mesh reference point 67 and the boundary points in the rectangular region 82. The lower end of the rectangular region 82 is at the position where “Lb” is subtracted from the y coordinate value of the lowermost point among the mesh reference point 67 and the boundary points in the rectangular region 82.

In the case of the rectangular region 83 of the LSB, the boundary points are sequentially searched to the left from the mesh reference point 66. In the search, whether a condition that the difference in the vertical direction between the boundary point as the search target and one of the other boundary points already searched is equal to or smaller than “Lb×2” is satisfied is determined. In the example of FIG. 15, all of the boundary points in the search direction satisfy the condition, and the rectangular region 83 including all of the searched boundary points is generated. The right end of the rectangular region 83 is the mesh reference point 66. The left end of the rectangular region 83 is at the position where “Lb” is subtracted from the x coordinate value of the leftmost boundary point among the boundary points detected in the search. The upper end of the rectangular region 83 is at the position where “Lb” is added to the y coordinate value of the uppermost point among the mesh reference point 66 and the boundary points in the rectangular region 83. The lower end of the rectangular region 83 is at the position where “Lb” is subtracted from the y coordinate value of the lowermost point among the mesh reference point 66 and the boundary points in the rectangular region 83.

Note that among the RSBs, there is an RSB in which the difference in the vertical direction between the mesh reference points at the left and right ends exceeds “Lb×2.” The RSB will be referred to as, for example, an right-side connected box (RCB). Similarly, an LSB in which the difference in the vertical direction between the mesh reference points at the left and right ends exceeds “Lb×2” will be referred to as, for example, an left-side connected box (LCB).

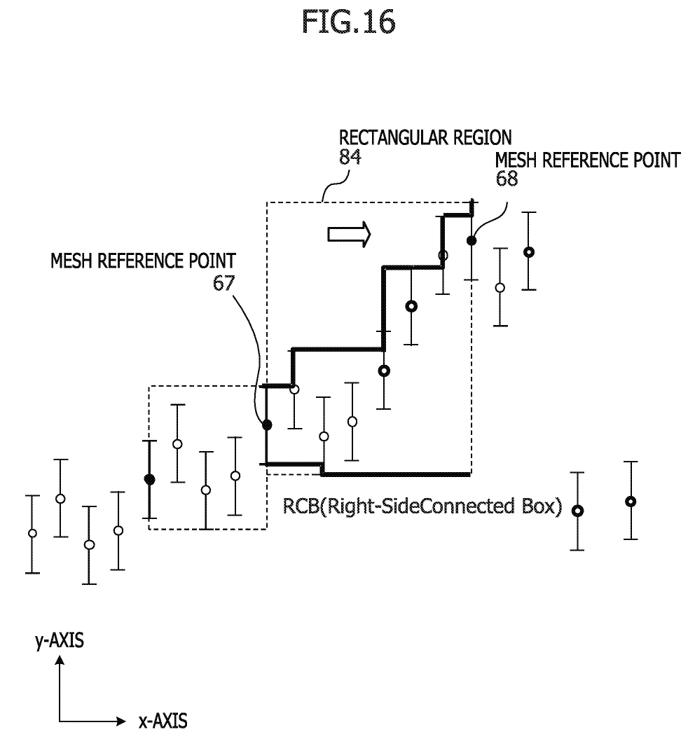

FIG. 16 depicts an example of generating the rectangular region of the RCB. In the example of FIG. 16, when the boundary points are sequentially searched to the right from the mesh reference point 67, another mesh reference point 68 becomes the search target before the boundary point not satisfying the condition that the difference in the vertical direction between the boundary point and one of the other boundary points already searched is equal to or smaller than “Lb×2.” In this case, a rectangular region 84 including all of the boundary points from the mesh reference point 67 to the mesh reference point 68 is generated. For example, the rectangular region 84 is generated by setting the mesh reference point 67 as the left end and setting the mesh reference point 68 as the right end. The upper end of the rectangular region 84 is at the position where “Lb” is added to the y coordinate value of the uppermost point among the mesh reference points 67 and 68 and the boundary points in the rectangular region 84. The lower end of the rectangular region 84 is at the position where “Lb” is subtracted from the y coordinate value of the lowermost point among the mesh reference points 67 and 68 and the boundary points in the rectangular region 84.

In this way, one rectangular region 84 is generated even when the difference in the vertical direction between the mesh reference points 67 and 68 at the left and right ends exceeds “Lb×2.”

There may be a boundary point not included in any of the rectangular regions after generating the rectangular regions from the mesh reference points corresponding to the gene information points. In that case, a mesh reference point not related to the gene information points is added.

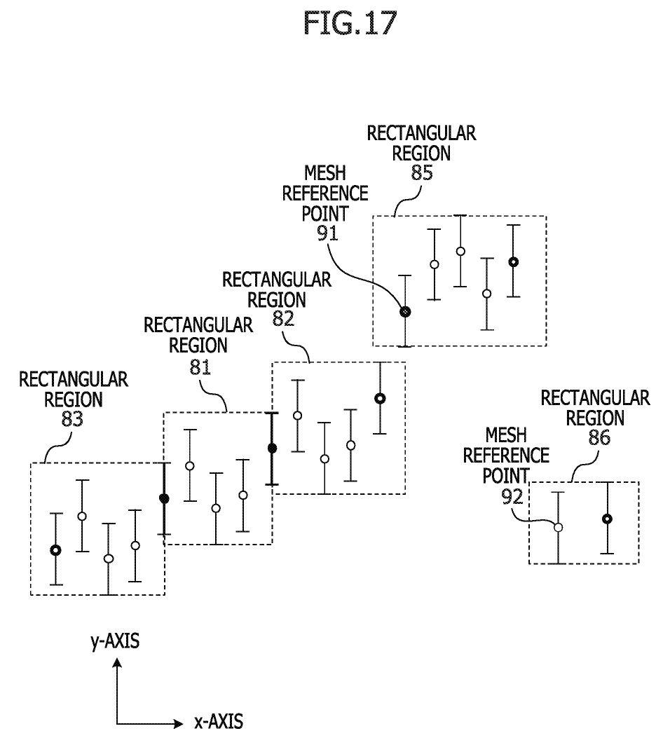

FIG. 17 depicts an example of adding the mesh reference point. In the example of FIG. 17, a boundary point on the leftmost side among the boundary points not included in any of the rectangular regions 81 to 83 is additionally set as a mesh reference point 91. A rectangular region 85 is then generated based on the newly set mesh reference point 91.

The rectangular region 85 includes a boundary point satisfying the condition that the difference in the vertical direction between the boundary point and one of the other boundary points already search is equal to or smaller than “Lb×2” when the boundary points are searched to the right from the mesh reference point 91. Among the points included in the rectangular region 85, the mesh reference point 91 is on the leftmost side. Therefore, the left end of the rectangular region 85 is at the position where “Lb” is subtracted from the x coordinate value of the mesh reference point 91. The right end of the rectangular region 85 is at the position where “Lb” is added to the x coordinate value of the rightmost boundary point in the rectangular region 85. The upper end of the rectangular region 85 is at the position where “Lb” is added to the y coordinate value of the uppermost point among the mesh reference point 91 and the boundary points in the rectangular region 85. The lower end of the rectangular region 85 is at the position where “Lb” is subtracted from the y coordinate value of the lowermost point among the mesh reference point 91 and the boundary points in the rectangular region 85.

In the example of FIG. 17, there is a boundary point not included in any of the rectangular regions 81 to 83 and 85 after generating the rectangular region 85. Therefore, a boundary point on the leftmost side among the boundary points not included in any of the rectangular regions 81 to 83 and 85 is additionally set as a mesh reference point 92. A rectangular region 86 is then generated based on the mesh reference point 92. The method of deciding the vertical and horizontal ranges of the rectangular region 86 is similar to the case of the rectangular region 85.

In this way, the addition of the mesh reference point and the generating process of the rectangular region are repeated as long as there is a boundary point not included in any of the rectangular regions. As a result, the rectangular regions are generated so that all of the boundary points are included in one of the rectangular regions.

When all of the boundary points are included in one of the rectangular regions, two adjacent rectangular regions with the difference in the y-axis equal to or smaller than a given threshold are merged into one rectangular region. The rectangular region after the merge will be referred to as, for example, an merged box (MB).

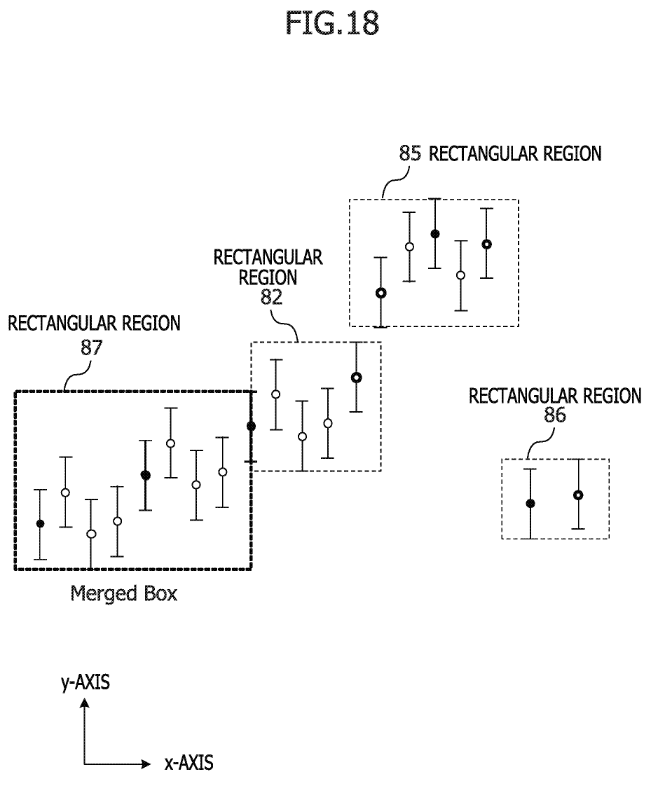

FIG. 18 depicts an example of merging the rectangular regions. In the example of FIG. 18, the rectangular region 83 and the rectangular region 81 illustrated in FIG. 17 are merged into one rectangular region 87. For example, if the difference between the upper ends and the difference between the lower ends of two adjacent rectangular regions are both equal to or smaller than a threshold, the rectangular regions are merged into one MB.

The number of rectangular regions may be reduced by merging the rectangular regions. The smaller the number of rectangular regions, the smaller the amount of processing of the fluid analysis based on the generated hierarchical structured grid. For example, the efficiency of the fluid analysis may be increased by merging the rectangular regions.

In this way, the rectangular regions are generated for each individual. The rectangular regions of each individual are uniquely determined according to the positions of the gene information points included in the individual.

The rectangular regions eventually generated according to each individual are evaluated by an evaluation formula. The evaluation is performed by using, for example, a multi-objective GA. The multi-objective GA is obtained by expanding the GA for multi-objective optimization. Examples of the method of the multi-objective GA suitable for solving a multi-objective optimization problem for optimizing a plurality of objective functions at the same time include vector evaluated genetic algorithms (VEGA), Pareto ranking, non-dominated sorting genetic algorithm-II (NSGA-II), and strength pareto evolutionary algorithm-II (SPEA2).

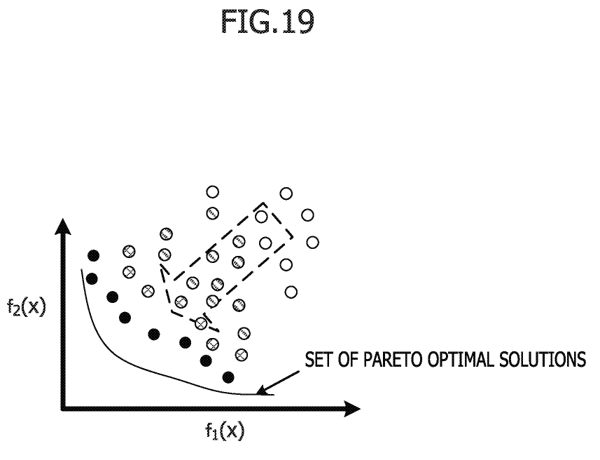

FIG. 19 depicts an example of the optimal solution search based on the multi-objective GA. For example, when it is difficult to improve two objective functions f₁(x) and f₂(x) at the same time, a solution that reduces the values of both of the objective functions as much as possible is a Pareto optimal solution. There are a plurality of Pareto optimal solutions, and the user selects an appropriate one of the Pareto optimal solutions.

A method other than the Pareto optimal solution may be used as a method of improving a plurality of objective functions at the same time. For example, the following equation for multiplying the objective functions by weights may be used to calculate the evaluation value (score).

score=w₁f₁+w₂f₂+w₃f₃+w₄f₄+w₅f₅

In the equation, f₁, f₂, f₃, f₄, and f₅ are objective functions, and w₁, w₂, w₃, w₄, and w₅ are weights of the objective functions.

Next, a procedure of the individual value evaluating process will be described in detail with reference to a flow chart.

FIG. 20 is a flow chart illustrating an example of the procedure of the individual evaluating process. The process illustrated in FIG. 20 will be described with reference to the step numbers.

[Step S111]

The rectangular region generating unit 140 selects a mesh reference point corresponding to each gene information point. For example, the rectangular region generating unit 140 calculates the distance between the gene information point and each mesh reference point and selects the mesh reference point at the shortest distance.

[Step S112]

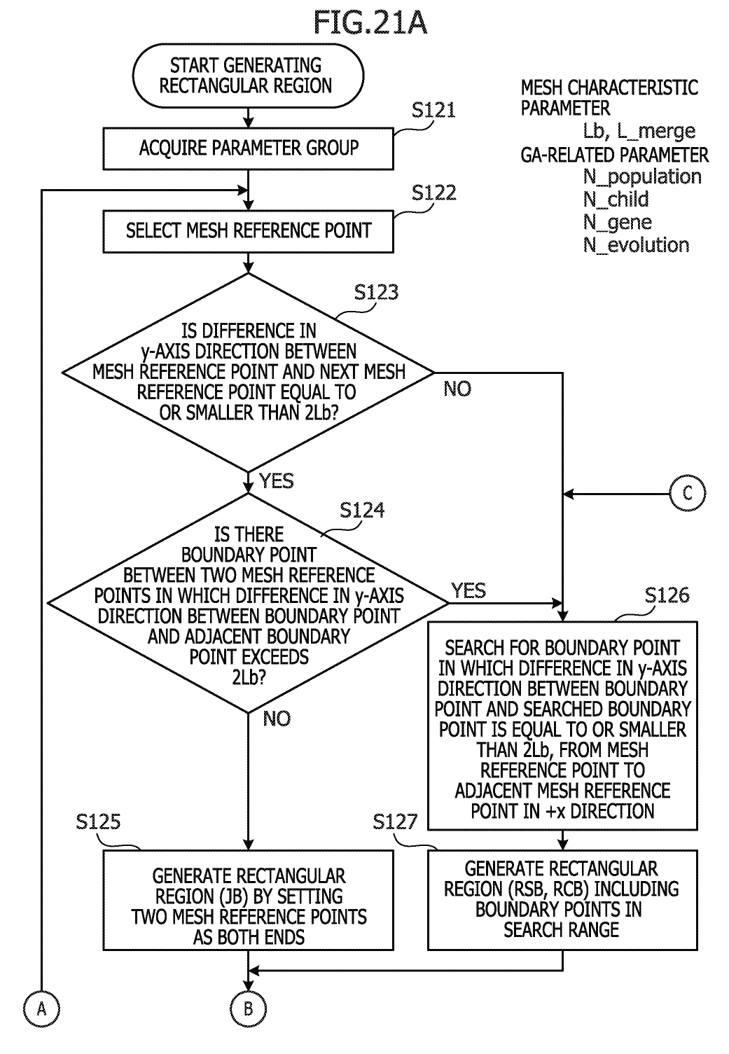

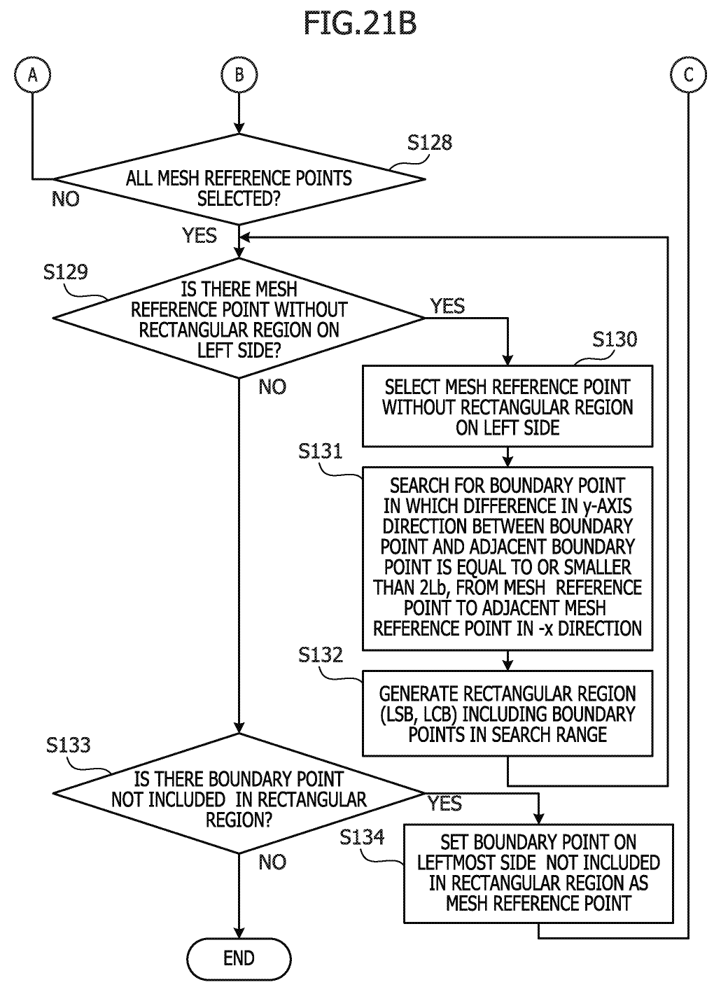

The rectangular region generating unit 140 generates rectangular regions based on each mesh reference point corresponding to the gene information point. The details of the rectangular region generating process will be described later (see FIGS. 21A and 21B).

[Step S113]

The rectangular region generating unit 140 merges adjacent rectangular regions with the deviation in the y-axis direction equal to or smaller than the threshold “L_merge” into one rectangular region. For example, the rectangular region generating unit 140 calculates the difference between the upper ends (maximum values of y-axis) and the difference between the lower ends (minimum values of y-axis) of two adjacent rectangular regions. The rectangular region generating unit 140 then merges the rectangular regions into one rectangular region if both of the difference between the upper ends and the difference between the lower ends are equal to or smaller than “L_merge.” The rectangular region after the merge is a minimum region containing the two merged rectangular regions.

[Step S114]

The rectangular region generating unit 140 calculates the evaluation value of the individual. The rectangular region generating unit 140 then sets the calculated evaluation value in the record of the evaluated individual in the population 121.

Next, a procedure of the rectangular region generating process will be described.

FIGS. 21A and 21B are flow charts illustrating an example of the procedure of the rectangular region generating process. The process illustrated in FIGS. 21A and 21B will be described with reference to the step numbers.

[Step S121]

The rectangular region generating unit 140 acquires the parameter group 131 from the parameter storing unit 130.

[Step S122] The rectangular region generating unit 140 selects one mesh reference point not selected. For example, the rectangular region generating unit 140 provides numbers to “N_gene” mesh reference points in ascending order of the x coordinate value. The rectangular region generating unit 140 then selects the mesh reference points in ascending order of the number. It is assumed here that an ith mesh reference point is selected.

[Step S123]

The rectangular region generating unit 140 determines whether the difference in the y-axis direction between the selected ith mesh reference point and an i+1th mesh reference point (next mesh reference point) is equal to or smaller than 2Lb. The rectangular region generating unit 140 advances the process to step S124 if the difference in the y-axis direction is equal to or smaller than 2Lb. The rectangular region generating unit 140 advances the process to step S126 if the difference in the y-axis direction exceeds 2Lb.

[Step S124]

The rectangular region generating unit 140 determines whether there is a boundary point in which the difference in the y-axis direction between the boundary point and an adjacent boundary point (including mesh reference point) exceeds 2Lb among the boundary points between the mesh reference point with an ith coordinate value of the x-axis and the mesh reference point with an i+1th coordinate value of the x-axis. The rectangular region generating unit 140 advances the process to step S126 when there is such a boundary point. The rectangular region generating unit 140 advances the process to step S125 when there is not such a boundary point.

[Step S125]

The rectangular region generating unit 140 generates a rectangular region by setting the ith mesh reference point and the i+1th mesh reference point as both ends. The generated rectangular region includes all of the boundary points between the mesh reference point with the ith coordinate value of the x-axis and the mesh reference point with the i+1th coordinate value of the x-axis. The distance between the boundary line of the generated rectangular region and the point included in the rectangular region is equal to or greater than Lb for all of the points. The generated rectangular region is a JB as illustrated in FIG. 14. The process then advances to step S128.

[Step S126]

The rectangular region generating unit 140 searches for a boundary point in which the difference in the y-axis direction between the boundary point and one of the searched boundary points (including ith mesh reference point) is equal to or smaller than 2Lb, from the ith mesh reference point to the i+1th mesh reference point in the positive direction of the x-axis. When the rectangular region generating unit 140 finds a boundary point in which the difference in the y-axis direction between the boundary point and the searched boundary point exceeds 2Lb for all of the searched boundary points, the rectangular region generating unit 140 includes the boundary points searched prior to the boundary point in the rectangular region to be generated. When the rectangular region generating unit 140 reaches the i+1th mesh reference point before finding the boundary point in which the difference in the y-axis direction between the boundary point and the searched boundary point exceeds 2Lb for all of the searched boundary points, the rectangular region generating unit 140 includes the boundary points up to the i+1th mesh reference point in the rectangular region to be generated. When the rectangular region generating unit 140 completes searching all of the boundary points before finding the boundary point in which the difference in the y-axis direction between the boundary point and the searched boundary point exceeds 2Lb for all of the searched boundary points, the rectangular region generating unit 140 includes all of the reference points on the right side of the ith mesh reference point in the rectangular region to be generated.

[Step S127]

The rectangular region generating unit 140 generates a rectangular region including the boundary points determined to be included in the rectangular region in the search of step S126. The distance between the boundary line of the generated rectangular region and the point is equal to or greater than Lb for all of the points included in the rectangular region. The generated rectangular region is an RSB as illustrated in FIG. 15 or an RCB as illustrated in FIG. 16.

[Step S128]

The rectangular region generating unit 140 determines whether all of the mesh reference points are selected. The rectangular region generating unit 140 advances the process to step S129 when all of the mesh reference points are selected. The rectangular region generating unit 140 advances thee process to step S122 when there is a mesh reference point not selected.

[Step S129]

The rectangular region generating unit 140 determines whether there is a mesh reference point for which the rectangular region is not generated on the left side. The rectangular region generating unit 140 advances the process to step S130 when there is such a mesh reference point. The rectangular region generating unit 140 advances the process to step S133 when there is not such a mesh reference point.

[Step S130]

The rectangular region generating unit 140 selects one of the mesh reference points without the rectangular region on the left side.

[Step S131] The rectangular region generating unit 140 searches for a boundary point in which the difference in the y-axis direction between the boundary point and one of the searched boundary points (including the selected mesh reference point) is equal to or smaller than 2Lb, from the mesh reference point selected in step S130 to the (i−1)th mesh reference point in the negative direction of the x-axis. When the rectangular region generating unit 140 finds a boundary point in which the difference in the y-axis direction between the boundary point and the searched boundary point exceeds 2Lb for all of the searched boundary points, the rectangular region generating unit 140 includes the boundary points searched prior to the boundary point in the rectangular region to be generated. When the rectangular region generating unit 140 reaches another mesh reference point before finding the boundary point in which the difference in the y-axis direction between the boundary point and the searched boundary point exceeds 2Lb for all of the searched boundary points, the rectangular region generating unit 140 includes the boundary points up to the mesh reference point in the rectangular region to be generated. When the rectangular region generating unit 140 completes searching all of the boundary points before finding the boundary point in which the difference in the y-axis direction between the boundary point and the searched boundary point exceeds 2Lb for all of the searched boundary points, the rectangular region generating unit 140 includes all of the reference points on the left side of the selected mesh reference point in the rectangular region to be generated.

[Step S132]

The rectangular region generating unit 140 generates a rectangular region including the boundary points determined to be included in the rectangular region in the search of step S131. The distance between the boundary line of the generated rectangular region and the point is equal to or greater than Lb for all of the points included in the rectangular region. The generated rectangular region is an LSB as illustrated in FIG. 15 or an LCB not illustrated. The rectangular region generating unit 140 then advances the process to step S129.

[Step S133]

The rectangular region generating unit 140 determines whether there is a boundary point not included in any of the rectangular regions. The rectangular region generating unit 140 advances the process to step S134 when there is such a boundary point. The rectangular region generating unit 140 ends the rectangular region generating process when there is not such a boundary point.

[Step S134]

The rectangular region generating unit 140 sets the boundary point on the leftmost side (with minimum x coordinate value) not included in the rectangular region as a new mesh reference point. The rectangular region generating unit 140 then advances the process to step S126.

In this way, the rectangular regions are generated according to the individuals. After the evaluation of the individuals, an evolution process of the population is executed based on the GA.

Next, the evolution process of the population will be described in detail.

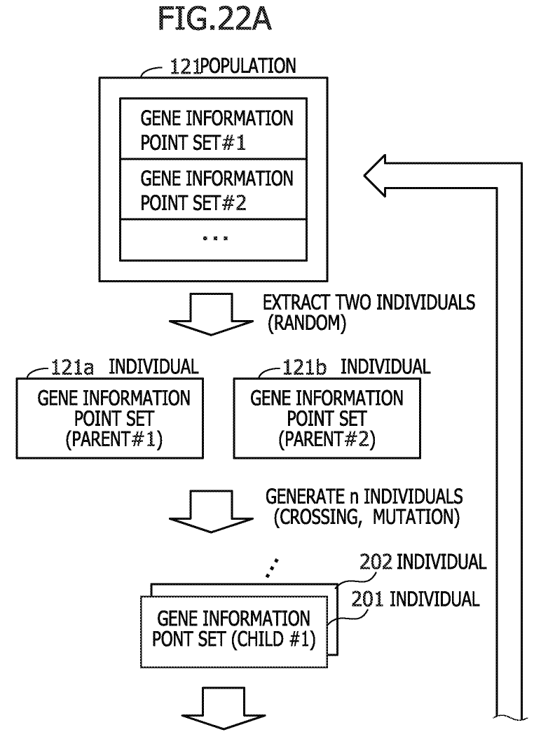

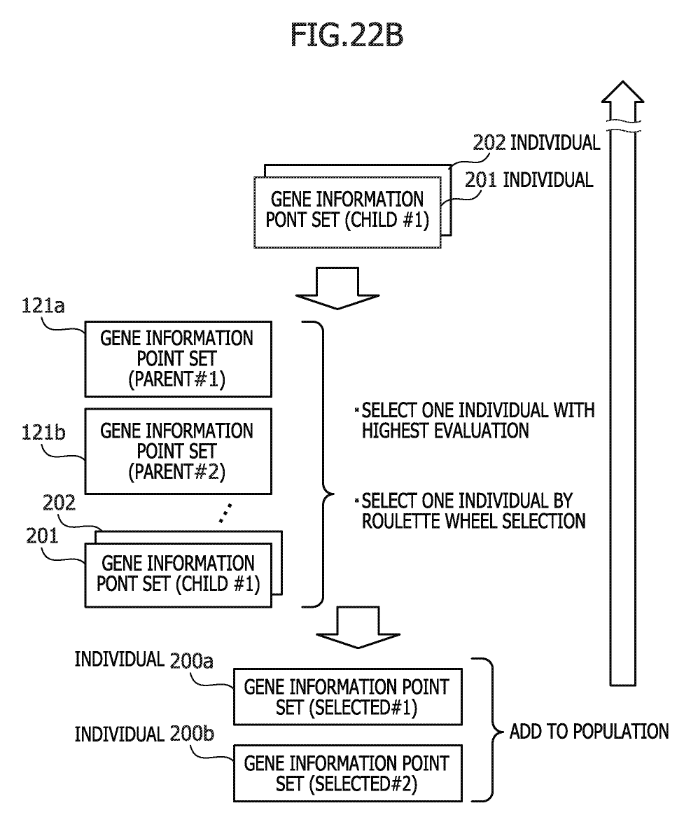

FIGS. 22A and 22B depict an example of a procedure of the evolution process of the population. First, the rectangular region generating unit 140 randomly extracts two individuals 121a and 121b from the population 121. The rectangular region generating unit 140 sets the extracted individuals 121a and 121b as “parent #1” and “parent #2,” respectively. The rectangular region generating unit 140 then executes operation, such as crossing and mutation, of the gene information point sets of the two parents to generate individuals 201, 202 and . . . as a plurality of children. The rectangular region generating unit 140 selects individuals to be left for the next generation from the individuals 121a and 121b as two parents and the individuals 201, 202 and . . . as a plurality of children. For example, the rectangular region generating unit 140 selects the most highly evaluated (small evaluation value) individual from the individuals 121a and 121b as parents and the individuals 201, 202 and . . . as a plurality of children. The rectangular region generating unit 140 also uses roulette wheel selection to select one individual. In the roulette wheel selection, a higher probability of selection is set for an individual with higher evaluation.

The rectangular region generating unit 140 adds two selected individuals 200a and 200b to the population 121. This completes the evolution of the first generation of the population 121. In extracting the two individuals 121a and 121b from the population 121, the individuals to be extracted may be selected by, for example, the roulette wheel selection so that a highly evaluated individual is more likely to be extracted.

Next, the procedure of generating the individuals 201, 202 and . . . as a plurality of children from the individuals 121a and 121b as two parents will be described in detail.

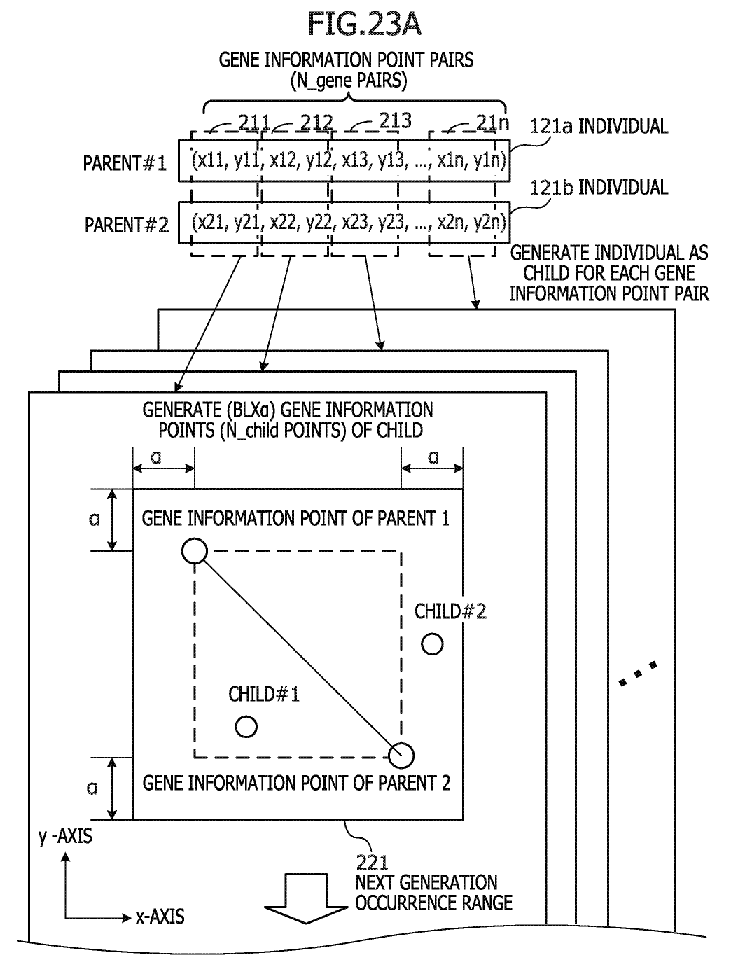

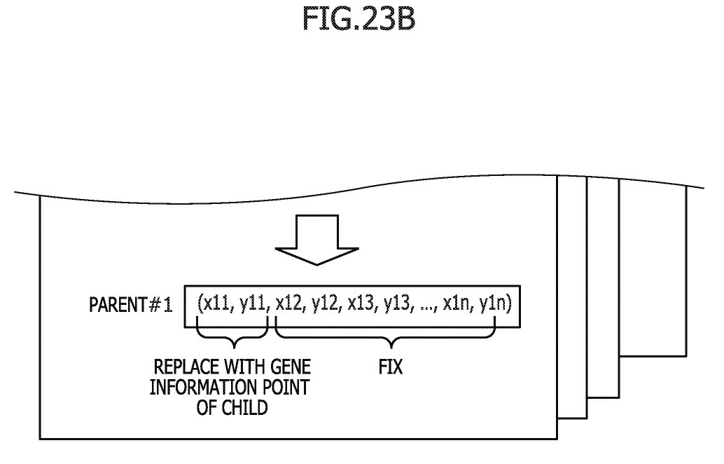

FIGS. 23A and 236 depict an example of the procedure of generating the individuals as children. The rectangular region generating unit 140 generates gene information point pairs 211, 212, 213, . . . and 21n each including a gene information point selected from the individual 121a as a parent and a gene information point selected from the individual 121b as a parent. For example, it is assumed that the gene information points in the individuals 121a and 121b as parents are arranged in ascending order of the x coordinate value. In this case, the rectangular region generating unit 140 puts the gene information points in the same order in the individuals 121a and 121b into the same gene information point pair. For example, the gene information point pair 211 includes a lead gene information point (x11, y11) in the individual 121a and a lead gene information point (x21, y21) in the individual 121b. The gene information point pair 212 includes a second gene information point (x12, y12) in the individual 121a and a second gene information point (x22, y22) in the individual 121b. The number of gene information points included in each individual is “N_gene,” and therefore, “N_gene” gene information point pairs 212, 213, . . . and 21n are generated.

The rectangular region generating unit 140 executes the process of generating the individuals as children for each of the gene information point pairs 211, 212, 213 and . . . , 21n. For example, when the rectangular region generating unit 140 generates individuals as children based on the gene information point pair 211, the rectangular region generating unit 140 applies a crossing process to the gene information point pair 211. For example, a method called blend crossover operator (BLX-α) may be used for the crossing.

For example, the rectangular region generating unit 140 sets a next generation occurrence range 221 based on two gene information points included in the gene information point pair 211. The next generation occurrence range 221 is a rectangular range including two gene information points included in the gene information point pair 211. The y-coordinate of the upper end of the next generation occurrence range 221 is a value obtained by adding a given value α to the larger one of the y coordinate values of the two gene information points. The y-coordinate of the lower end of the next generation occurrence range 221 is a value obtained by subtracting the given value a from the smaller one of the y coordinate values of the two gene information points. The x-coordinate of the right end of the next generation occurrence range 221 is a value obtained by adding the given value a to the larger one of the x coordinate values of the two gene information points. The x-coordinate of the left end of the next generation occurrence range 221 is a value obtained by subtracting the given value a from the smaller one of the x coordinate values of the two gene information points.

The rectangular region generating unit 140 randomly generates “N_child” gene information points of children in the next generation occurrence range 221. For each of the gene information points of children, the rectangular region generating unit 140 fixes the gene information point not included in the gene information point pair 211 in the individual 121a as “parent #1” and replaces the gene information point (x11, y11) included in the gene information point pair 211 with the gene information point of the child. The individual after the replacement of the gene information point is an individual as a child. In this way, “N_child” individuals as children are generated from the gene information point pair 211.

The rectangular region generating unit 140 also applies a similar process to the gene information point pairs 212, 213, . . . and 21n other than the gene information point pair 211. “N-child” individuals as children are generated for each of the “N_gene” gene information point pairs 211, 212, 213, . . . and 21n, and eventually, “N_child×N_gene” individuals as children are generated.

The individuals of children generated in this way are used to execute the evolution process of the population 121 in the process illustrated in FIGS. 22A and 22B.

FIG. 24 is a flow chart illustrating an example of a procedure of the population evolution process based on the GA. The process illustrated in FIG. 24 will be described with reference to the step numbers.

[Step S141]

The rectangular region generating unit 140 randomly extracts two individuals as parents based on the GA from the population 121.

[Step S142] The rectangular region generating unit 140 generates “N_child×N_gene” individuals as children based on BLxα from two individuals as parents.

[Step S143]

The rectangular region generating unit 140 selects one individual as a child not evaluated.

[Step S144] The rectangular region generating unit 140 evaluates the selected individual. The details of the individual evaluating process are as illustrated in FIG. 20.

[Step S145]

The rectangular region generating unit 140 determines whether the evaluation of all of the individuals as children is completed. The rectangular region generating unit 140 advances the process to step S146 if the evaluation of all of the individuals as children is completed. The rectangular region generating unit 140 advances the process to step S143 if there is an individual as a child not evaluated.

[Step S146]

The rectangular region generating unit 140 selects an individual A with the best evaluation value from the two individuals as parents and the “N_child×N_gene” individuals as children.

[Step S147] The rectangular region generating unit 140 uses the roulette wheel selection to select one individual B from the two individuals as parents and the “N_child×N_gene” individuals as children.

[Step S148]

The rectangular region generating unit 140 adds the two individuals A and B selected in steps S146 and S147 to the population 121.

The evolution of the population is repeatedly executed until the end condition in step S105 of FIG. 10 is satisfied. The individual with the best evaluation (minimum evaluation value) is output as an optimal solution in step S107 of FIG. 10.

Note that in generating the hierarchical structured grid, the rectangular region generating unit 140 first generates the innermost rectangular region and then generates the rectangular region one stage outside based on the rectangular region.

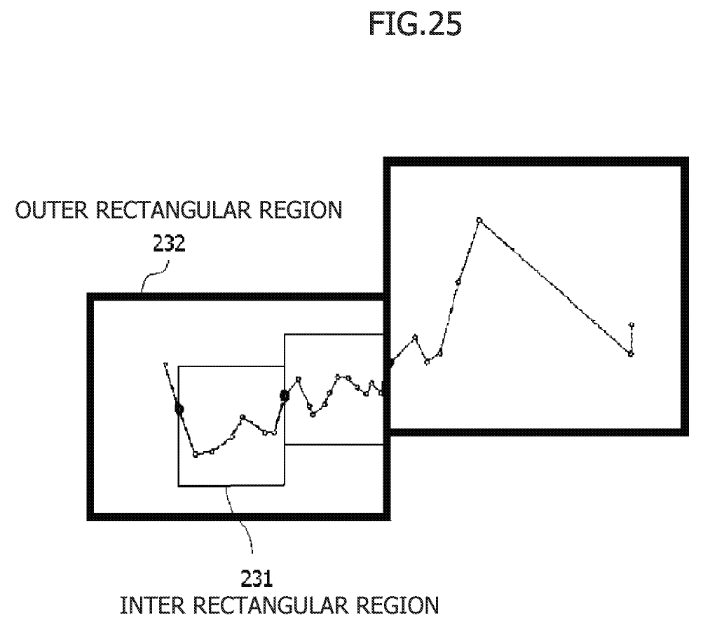

FIG. 25 depicts an example of the hierarchically generated rectangular regions. For example, the rectangular region generating unit 140 uses points at four ends of an inner rectangular region 231 as boundary points to generate an outer rectangular region 232. Here, the points at four ends belonging to the same inner rectangular region belong to the same outer rectangular region 232. The rectangular region generating unit 140 makes the number of inner rectangular regions 231 included in each outer rectangular region 232 as uniform as possible from the viewpoint of parallel processing. As a result, the loads between the CPUs in the connection process of the inside and the outside may be uniformed.

The outer rectangular region 232 may be generated by a process similar to the process for the inner rectangular region 231. However, to make the size of the rectangular region larger than the size of the inner rectangular region 231, the rectangular region generating unit 140 handles the parameters differently or changes the values of the parameters.

For example, the rectangular region generating unit 140 handles “Lb” (distance from boundary point to rectangular region end) as a distance from the end of the rectangular region inside in generating the rectangular region outside. The values of the parameters may be separately set for generating the rectangular region inside and for generating the rectangular region outside. In that case, the user sets “N_gene” for generating the rectangular region outside to the same value as “N_gene” for generating the innermost rectangular region or to a smaller value, for example. When the value of “N_gene” is gradually reduced for the outer rectangular regions to be generated, the number of outer rectangular regions gradually becomes smaller. However, adjacent rectangular regions may be easily merged by gradually increasing “L_merge” for the outer rectangular regions to be generated, and the number of rectangular regions may be reduced without adjusting “N_gene.”

The individual as an optimal solution of each level may be obtained by hierarchically generating the rectangular regions. Multilevel rectangular regions are uniquely determined based on the individual output as an optimal solution in each level. The three-dimensional hierarchical structure grid may be generated based on the rectangular regions corresponding to the individuals as optimal solutions. For example, an appropriate hierarchical structured grid may be automatically generated. The generated three-dimensional hierarchical structured grid may be used to execute an analysis, such as fluid simulation, to thereby efficiently execute an analysis with sufficient analysis accuracy.

### Third Embodiment

Next, a third embodiment will be described. In the third embodiment, a plane object for generating a rectangular region is rotated to allow generating a more highly evaluated rectangular region.

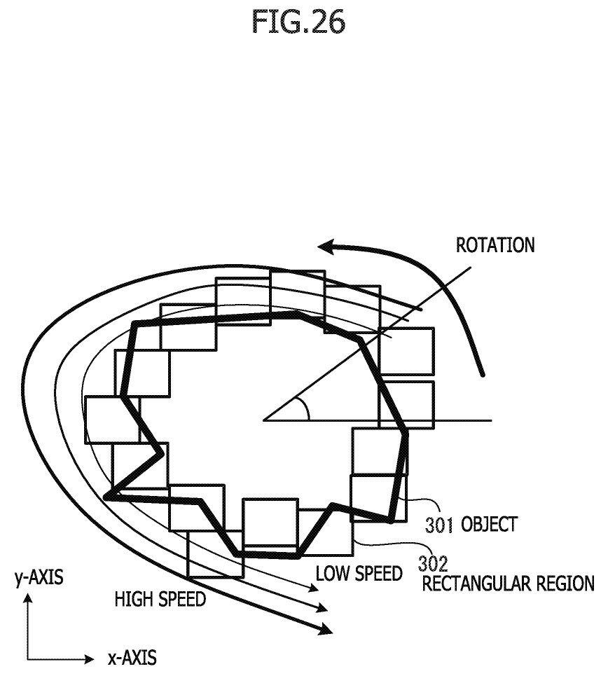

FIG. 26 depicts an example of rotating the object in the analysis space. In the CFD, the rotation of the object in the analysis space does not obstruct the calculation analysis in many cases if the rotation is within the horizontal coordinates perpendicular to the gravity. FIG. 26 illustrates a flow of a fluid around an object 301 placed on a horizontal plane and a rectangular region 302 for analyzing the movement of the fluid when the object 301 is viewed from the direction perpendicular to the gravity.

For example, a case of analyzing the movement of the fluid around the object 301 will be considered. The speed of the fluid is low near the object 301, and the speed increases with an increase in the distance from the object 301. Detailed analysis is performed by generating fine rectangular regions 302 at locations where the speed of the fluid is low.

In the case as illustrated in FIG. 26, the object 301 may be rotated in the horizontal plane about the center of gravity of the object 301, for example. As a result of the rotation of the object 301, the boundary of the region of the object 301 and the region of the fluid is also rotated. Along with the rotation of the boundary, the coordinates of the boundary point set on the boundary are also converted according to the rotation. Even when the object 301 is rotated, the rectangular region includes sides parallel to the x-axis and sides parallel to the y-axis.

In the third embodiment, the rectangular region generating unit 140 rotates the object at various angles and generates the rectangular regions based on the boundaries of the object at different rotation angles. A highly evaluated rectangular region may be specified from the rectangular regions generated in this way to generate a more highly evaluated rectangular region.

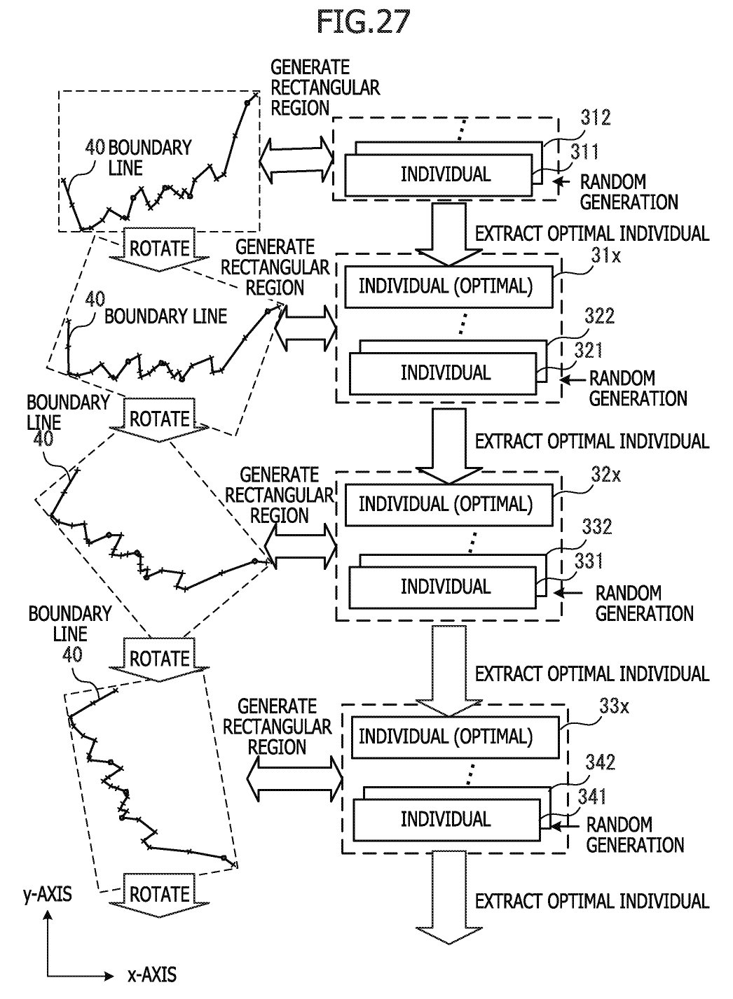

FIG. 27 depicts an example of generating individuals when the object is rotated. For example, the rectangular region generating unit 140 randomly generates gene information points to generate first individuals 311, 312 and . . . . The rectangular region generating unit 140 then generates rectangular regions corresponding to the individuals 311, 312 and . . . based on the boundary line 40 not rotated (rotation angle of 0 degrees). The rectangular region generating unit 140 evaluates the generated rectangular regions and extracts an individual 31x (optimal individual) with the highest evaluation of the generated rectangular region from the individuals 311, 312 and . . . .

The rectangular region generating unit 140 applies the extracted individual 31x to the rectangular region generating process after the rotation of the boundary line 40. In this case, the rectangular region generating unit 140 may convert the coordinates of the gene information points in the individual 31x by rotating the coordinates Δα degrees.

For example, the rectangular region generating unit 140 randomly generates gene information points to generate new individuals 321, 322 and . . . The rectangular region generating unit 140 generates the individuals 321, 322 and . . . based on the boundary line 40 (rotation angle of Δα degrees) rotated by a given angle (Δα degrees). Next, the rectangular region generating unit 140 generates rectangular regions corresponding to the generated individuals 321, 322 and . . . and the individual 31x as an optimal individual at the previous rotation angle. The rectangular region generating unit 140 then evaluates the generated rectangular regions and extracts an individual 32x (optimal individual) with the highest evaluation of the generated rectangular region from the individuals 321, 322 and . . . and the individual 31x as an optimal individual at the previous rotation angle.

The rectangular region generating unit 140 applies the extracted individual 32x to the rectangular region generating process after the rotation of the boundary line 40. In this case, the rectangular region generating unit 140 may convert the coordinates of the gene information points in the individuals 32x by rotating the coordinates Δα degrees.

Subsequently, the rectangular region generating unit 140 generates individuals 331, 332 and . . . and generates rectangular regions corresponding to the individuals 32x, 331, 332 and . . . based on the boundary line 40 (rotation angle of 2Δα degrees further rotated by the given angle (Δα degree). The rectangular region generating unit 140 evaluates the generated rectangular regions and extracts an individual 33x (optimal individual) with the highest evaluation of the generated rectangular region from the individuals 32x, 331, 332 and . . . to convert the coordinates of rotation.

Next, the rectangular region generating unit 140 generates new individuals 341, 342 and . . . and generates rectangular regions corresponding to the individuals 33x, 341, 342 and . . . based on the boundary line 40 (rotation angle of 3Δα degrees) further rotated by the given angle (Δα degrees). The rectangular region generating unit 140 evaluates the generated rectangular regions and extracts the individual (optimal individual) with the highest evaluation of the generated rectangular region from the individuals 33x, 341, 342 and . . . .

Subsequently, the rectangular region generating unit 140 repeats the rotation of the boundary line 40 and the generation of the rectangular regions until the angle is rotated at a given rotation angle. Note that the center of rotation is, for example, the center of gravity (intersection point of two diagonals) of the rectangular region containing the boundary line 40.

In the third embodiment, what kind of rectangular region is to be generated from each individual is determined by the gene information point set and the rotation angle of the boundary line 40. Therefore, the rectangular region generating unit 140 also records the rotation angle at the time of the evaluation of each individual as information of the individual.

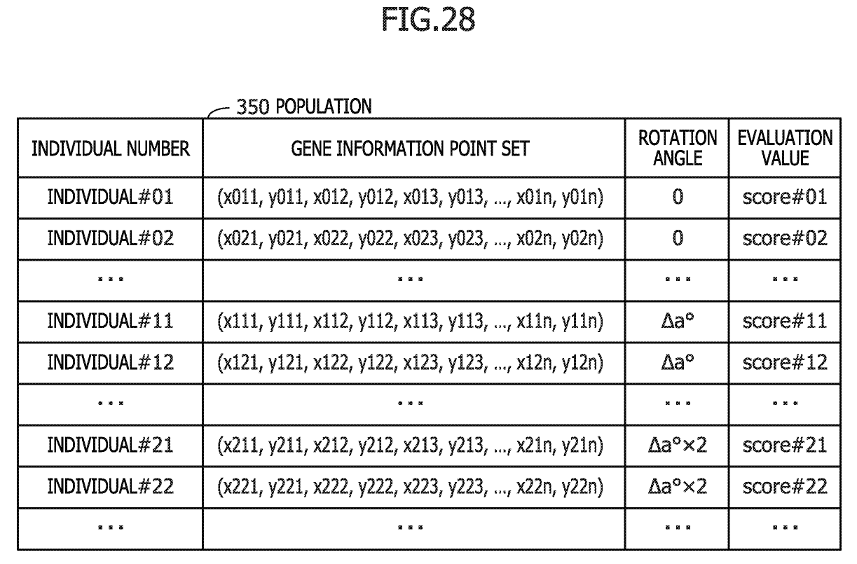

FIG. 28 depicts an example of the information of the population according to the third embodiment. In the third embodiment, the record indicating each individual in a population 350 includes the rotation angle. The rotation angle is the rotation angle of the boundary line 40 at the time of the evaluation of the individual.

Next, the procedure of the rectangular region generating process involving the rotation of the boundary line 40 will be described in detail.

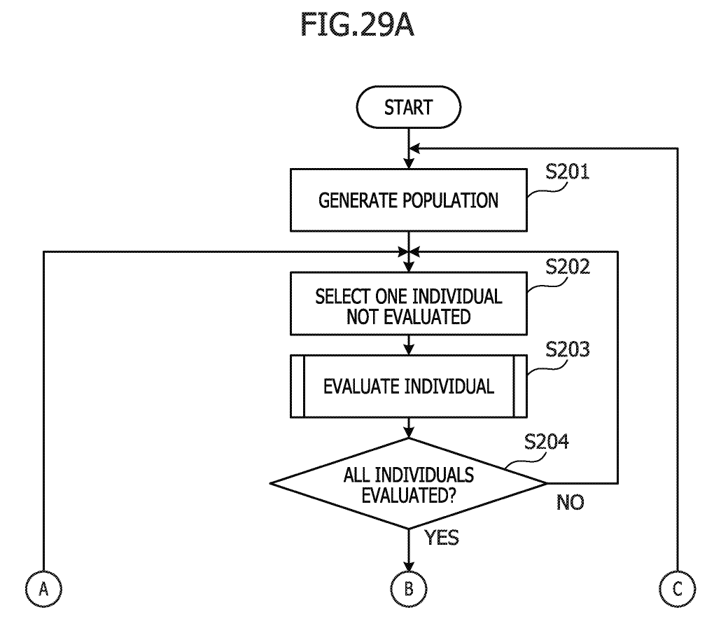

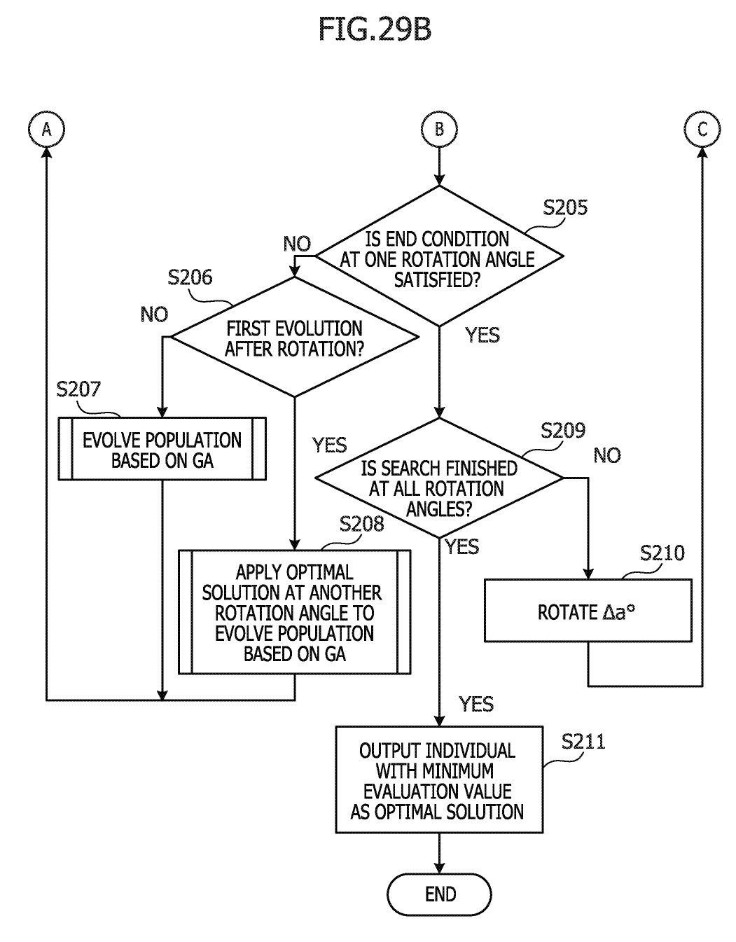

FIGS. 29A and 29B are flow charts illustrating an example of the rectangular region generating process involving the rotation of the boundary. Steps S201 to S204 and S207 in the process illustrated in FIGS. 29A and 29B are processes similar to steps S101 to S104 and S106 in the second embodiment illustrated in FIG. 10. Processes different from the second embodiment illustrated in FIGS. 29A and 29B will be described with reference to the step numbers.

[Step S205]

The rectangular region generating unit 140 determines whether an end condition of the repeated process at one rotation angle is satisfied. For example, the rectangular region generating unit 140 determines that the end condition is satisfied when the number of evolutions based on the GA at the current rotation angle exceeds the limit value “N_evolution” or when an individual with the evaluation value equal to or greater than a given value is detected. The rectangular region generating unit 140 advances the process to step S209 when the end condition is satisfied. The rectangular region generating unit 140 advances the process to step S206 when the end condition is not satisfied.

[Step S206]

The rectangular region generating unit 140 determines whether the evolution to be performed next is first evolution after the rotation. The rectangular region generating unit 140 determines that the evolution is the first evolution when step S208 is not executed yet after the rotation in step S210. The rectangular region generating unit 140 advances the process to step S208 if the evolution to be performed next is the first evolution. The rectangular region generating unit 140 advances the process to step S207 if the evolution to be performed next is second or subsequent evolution after the rotation.

[Step S208]

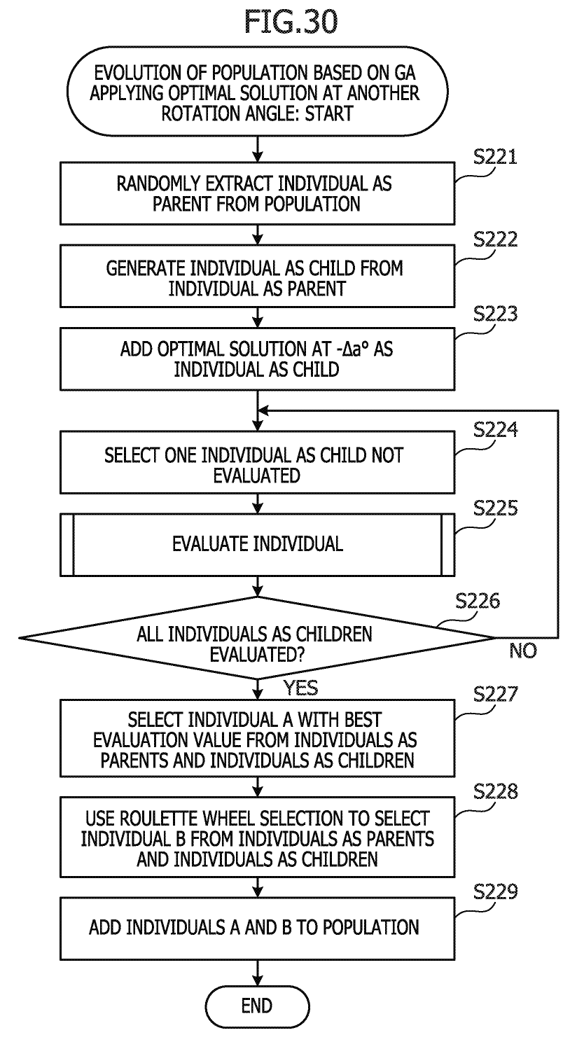

The rectangular region generating unit 140 applies the optimal solution at another rotation angle to execute the evolution process of the population 350 based on the GA. For example, the rectangular region generating unit 140 applies the optimal solution at a rotation angle that is Δα smaller than the current rotation angle. The details of the process will be described later (see FIG. 30). The rectangular region generating unit 140 then advances the process to step S202.

[Step S209]

The rectangular region generating unit 140 determines whether the search is finished at all of the rotation angles. The rectangular region generating unit 140 advances the process to step S211 when the search is finished at all of the rotation angles. The rectangular region generating unit 140 advances the process to step S210 if there is a rotation angle not searched.

[Step S210]

The rectangular region generating unit 140 rotates the boundary line 40 by Δα degrees. For example, the rectangular region generating unit 140 executes a coordinate conversion process of rotating the coordinates of the boundary point by Δα degrees. The rectangular region generating unit 140 then advances the process to step S201.

[Step S211]

The rectangular region generating unit 140 regards the individual with the minimum evaluation value in the population 350 as an optimal solution and outputs the optimal solution.

Next, the evolution process of the population 350 based on the GA applying the optimal solution at another rotation angle will be described in detail.

FIG. 30 is a flow chart illustrating an example of the procedure of the evolution process of a population based on GA applying the optimal solution at another rotation angle. Steps S221, S222, and S224 to S229 in the process illustrated in FIG. 30 are the same as steps S141 to S148 of the process in the second embodiment illustrated in FIG. 24, respectively. For example, the process of step S223 different from the second embodiment is as follows.

[Step S223]

The rectangular region generating unit 140 regards the optimal solution at the rotation angle, which is the current rotation angle minus Δα (−Δα), as an individual of a child and adds the individual. In this case, the rectangular region generation unit 140 may convert the coordinates of the gene information points included in the individual as the optimal solution by rotating the coordinates Δα degrees according to the current rotation angle of the boundary line 40.

In this way, step S223 is added, and the evolution process of the population 350 is executed by applying the optimal solution at another rotation angle. A highly evaluated individual may be efficiently obtained by applying the optimal solution at another rotation angle.

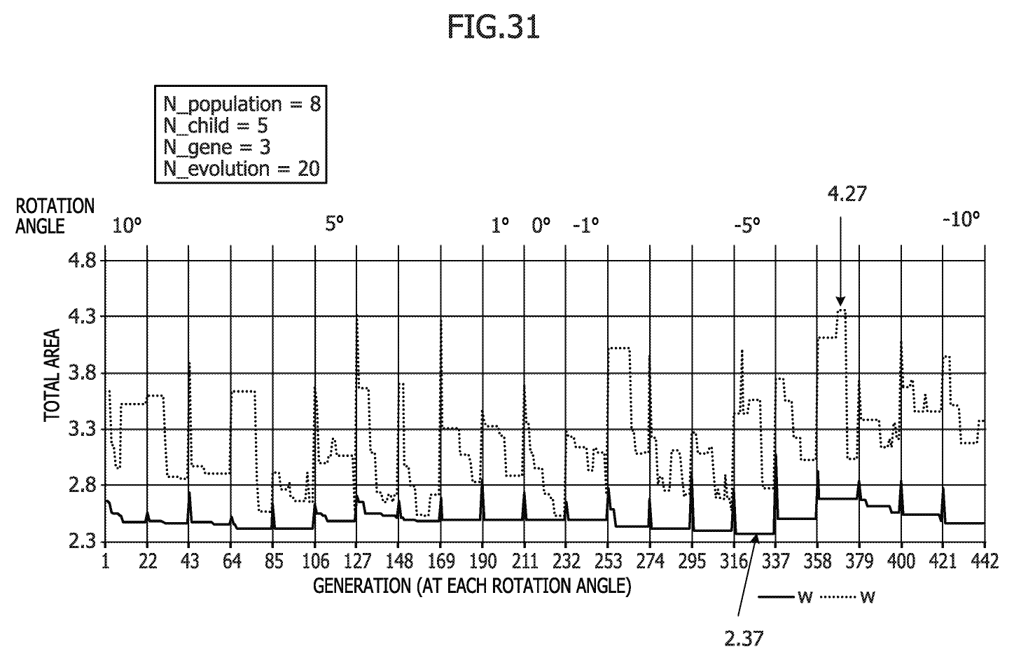

FIG. 31 depicts differences between total areas of the rectangular regions depending on whether an optimal solution at another rotation angle is applied. In the example of FIG. 31, the rotation angle is rotated by one degree at a time (Δα=1 degree) in a range from −10 degrees to +10 degrees. A solid polygonal line indicates the case in which the optimal solution at another rotation angle is applied, and a dotted polygonal line indicates the case in which the optimal solution at another rotation angle is not applied. The total area of the rectangular regions reaches 4.27 at the maximum when the optimal solution at another rotation angle is not applied. On the other hand, the rectangular regions may be reduced to 2.37 by applying the optimal solution at another rotation angle.

It may also be recognized from the polygonal line of the case in which the optimal solution at another rotation angle is applied that the rectangular regions with smaller areas may be generated by rotating the boundary, compared to the case in which, for example, the rectangular regions are generated only at the rotation angle of 0 degrees without rotating the boundary.

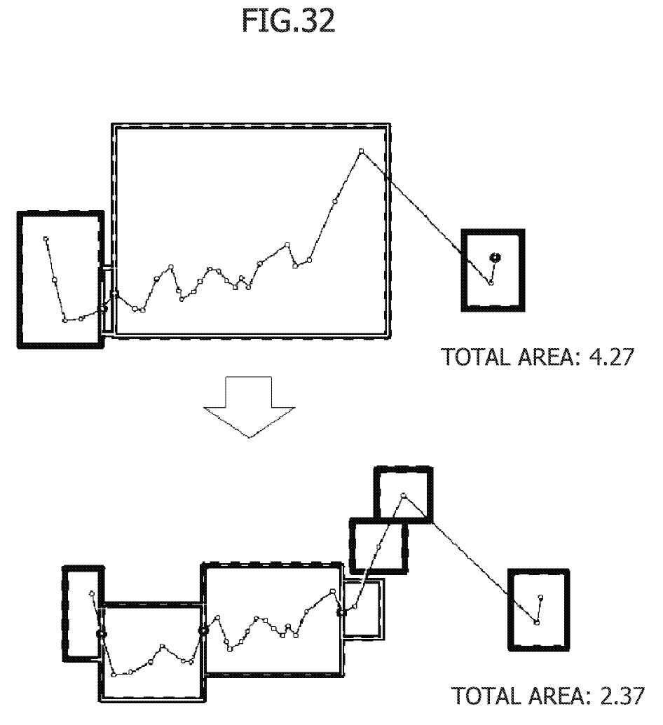

FIG. 32 depicts an example of reducing the total area of the rectangular regions based on the optimization using the GA. When the GA is not effectively used (without the repetitions using the GA), the total area of the rectangular regions is 4.27 in a bad case. However, the rectangular regions with a total area of 2.37 may be generated by effectively using the GA for the optimization.

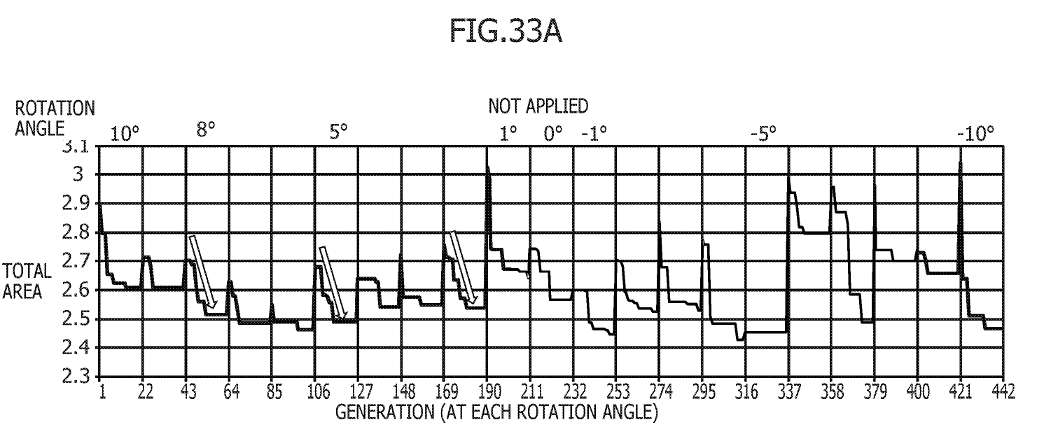

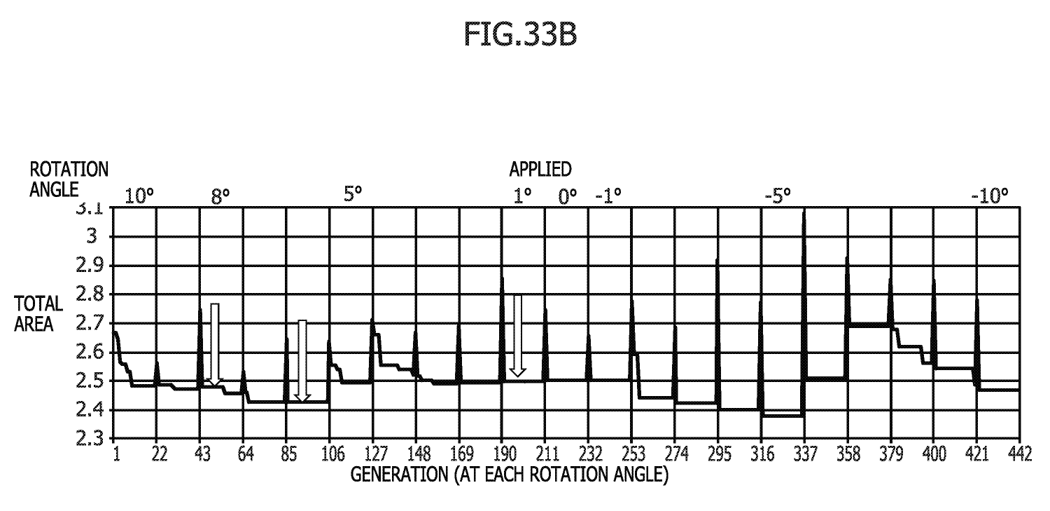

FIGS. 33A and 33B depict differences in convergence depending on whether an optimal solution at another rotation angle is applied. FIG. 33A illustrates a graph of the case in which the optimal solution at another rotation angle is not applied, and FIG. 33B illustrates a graph of the case in which the optimal solution at another rotation angle is applied.

For example, a 43rd generation is a first generation when the rotation angle is eight degrees. When the optimal solution at the previous rotation angle is not applied, individuals that generate rectangular regions with smaller total area are obtained step-by-step through repetitions over some generations. On the other hand, when the optimal solution at the previous rotation angle is applied, individuals that generate rectangular regions with a significantly small total area are obtained in the generation following the 43rd generation.

In this way, the number of repetitions before the convergence of the solution is reduced by applying the optimal solution at another rotation angle. For example, a favorable solution may also be obtained even when the number of generations in the GA at one rotation angle is reduced. This improves the efficiency of generating the rectangular regions.

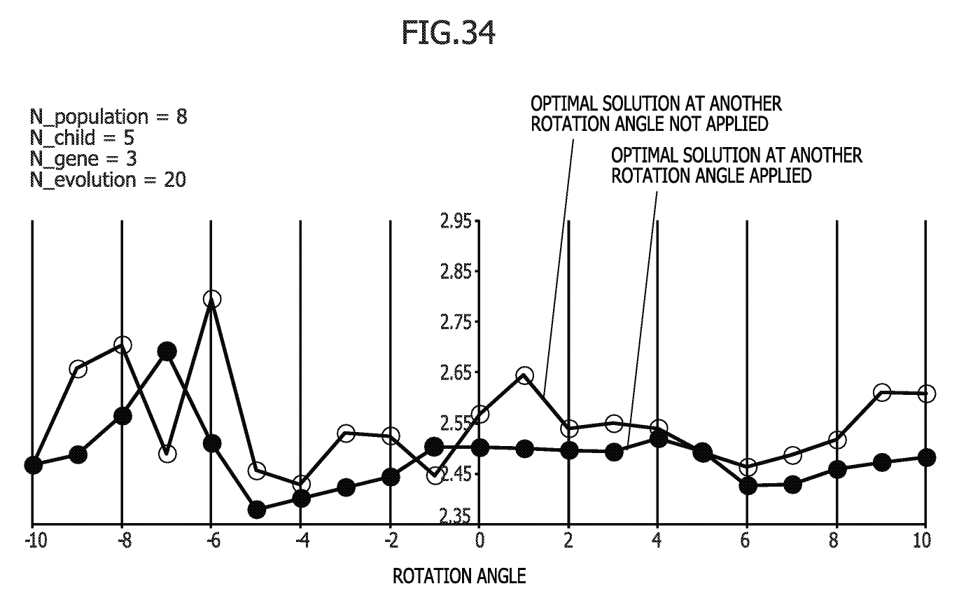

FIG. 34 depicts differences between the total areas of the rectangular regions obtained at the same rotation angle depending on whether the optimal solution at another rotation angle is applied. In FIG. 34, a black circle indicates the total area of the best rectangular regions at each angle when the optimal solution at another rotation angle is applied. A white circle indicates the total area of the best rectangular regions at each angle when the optimal solution at another rotation angle is not applied. In the example illustrated in FIG. 34, the results are improved at sixteen of twenty rotation angles by applying the optimal solution at a neighborhood rotation angle.

Although the embodiments have been illustrated, the configurations of the components illustrated in the embodiments may be replaced with other configurations with similar functions. Other arbitrary components or processes may also be added. Two or more arbitrary components (features) in the embodiments may also be combined.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing therein a divided region generating program for causing a computer to execute a process comprising:
referring to boundary information indicating a boundary line of a region occupied by an object arranged in a target region and another region on a plane in the target region to generate a plurality of first gene information point sets each including a plurality of first gene information points, in which a number of the plurality of first gene information points corresponds to a first set value related to a degree of division of the target region;
deciding a plurality of first reference points on the boundary line for each of the plurality of first gene information point sets based on the plurality of first gene information points included in the first gene information point set;
generating a plurality of first rectangular regions for each of the plurality of first gene information point sets, in which each of the plurality of first gene rectangular regions includes by a first side including one of the plurality of first reference points and a second side not including any of the plurality of first reference points, and the second side and the boundary line are separated by a second set value indicating a distance to the boundary line;
using a genetic algorithm based on a selected first gene information point set selected from the plurality of first gene information point sets to generate a plurality of second gene information point sets each including a plurality of second gene information points, in which a number of the plurality of second gene information points corresponds to the first set value;
deciding a plurality of second reference points on the boundary line for each of the plurality of second gene information point sets based on the plurality of second gene information points included in the second gene information point set;
generating a plurality of second rectangular regions for each of the plurality of second gene information point sets, in which each of the plurality of second rectangular regions includes a first side including one of the plurality of second reference points and a second side not including any of the plurality of second reference points, and the second side and the boundary line are separated by the second set value;
specifying one of the plurality of first gene information point sets and the plurality of second gene information point sets based on evaluation of the plurality of first rectangular regions generated based on the first gene information point set for each of the plurality of first gene information point sets and evaluation of the plurality of second rectangular regions generated based on the second gene information point set for each of the plurality of second gene information point sets; and
dividing the target region based on the plurality of first rectangular regions or the plurality of second rectangular regions generated according to the specified first gene information point set or second gene information point set.

2. The non-transitory computer-readable recording medium according to claim 1, wherein
in the deciding the plurality of first reference points, a boundary point closest to a first gene information point among a plurality of boundary points set in advance on the boundary line is decided as a first reference point corresponding to the first gene information point.

3. The non-transitory computer-readable recording medium according to claim 2, wherein
in the generating the plurality of first rectangular regions, a first rectangular region is generated, the first rectangular region including two first reference points adjacent to each other when the plurality of first reference points are arranged based on coordinate value of a first axis of the plane and including all of first boundary points set between the two first reference points on the boundary line, when a difference in coordinate value of a second axis perpendicular to the first axis between the two first reference points is equal to or smaller than a given value, and a difference in coordinate value of the second axis between a first boundary point and another adjacent boundary point is equal to or smaller than the given value for all of the first boundary points set between the two first reference points on the boundary line.

4. The non-transitory computer-readable recording medium according to claim 3, wherein
in the generating the plurality of first rectangular regions, boundary points are set as search targets in ascending order of distance from a first reference point as a starting point based on the coordinate value of the first axis to perform a search in a positive or negative direction of the first axis from the first reference point, and a first rectangular region is generated, the first rectangular region including the first reference point and including second boundary points between the first reference point and a boundary point as a search target, when a difference between a coordinate value of the second axis of the first reference point and a coordinate value of the second axis of the boundary point as the search target exceeds the given value and a difference between a coordinate value of the second axis of a second boundary point and the coordinate value of the second axis of the boundary point as the search target exceeds the given value for all of the second boundary points.

5. The non-transitory computer-readable recording medium according to claim 2, wherein
in the generating the plurality of first rectangular regions, when there are boundary points not included in any of the generated first rectangular regions after the generation of the first rectangular regions based on the plurality of first reference points, one of the boundary points not included in any of the first rectangular regions is set as an additional reference point to generate a new first rectangular region based on the additional reference point.

6. The non-transitory computer-readable recording medium according to claim 1, wherein
in the generating the plurality of first rectangular regions, two of the plurality of first rectangular regions are merged into one rectangular region when a deviation between opposite sides of the two of the plurality of first rectangular regions including a specific first reference point shared by adjacent first rectangular regions is equal to or smaller than a given value in the adjacent first rectangular regions.

7. The non-transitory computer-readable recording medium according to claim 1, the program causing the computer to execute the process further comprising
generating an outer rectangular region containing one or a plurality of rectangular regions of the plurality of first rectangular regions or the plurality of second rectangular regions generated according to the specified first gene information point set or second gene information point set.

8. The non-transitory computer-readable recording medium according to claim 1, the program causing the computer to execute the process further comprising:
rotating the boundary line by a given angle at a time in the plane; and
executing the referring to the boundary information to generate the plurality of first gene information point sets, the deciding the plurality of first reference points, the generating the plurality of first rectangular regions, the using the genetic algorithm to generate the plurality of second gene information point sets, the deciding the plurality of second reference points, and the generating the plurality of second rectangular regions, every time the boundary line is rotated.

9. The non-transitory computer-readable recording medium according to claim 8, wherein
in the using the genetic algorithm to generate the plurality of second gene information point sets after rotation of the boundary line from a first rotation angle to a second rotation angle, a first gene information point set or a second gene information point set selected from the plurality of first gene information point sets or the plurality of second gene information point sets generated at the first rotation angle based on an evaluation value is included in the second gene information point set after the rotation to the second rotation angle.

10. A divided region generating apparatus comprising:
a memory that stores boundary information indicating a boundary line of a region occupied by an object arranged in a target region and another region on a plane in the target region; and
a processor coupled to the memory and that executes a process including:
referring to the boundary information to generate a plurality of first gene information point sets each including a plurality of first gene information points, in which a number of the plurality of first gene information points corresponds to a first set value related to a degree of division of the target region;
deciding a plurality of first reference points on the boundary line for each of the plurality of first gene information point sets based on the plurality of first gene information points included in the first gene information point set;
generating a plurality of first rectangular regions for each of the plurality of first gene information point sets, in which each of the plurality of first gene rectangular regions includes a first side including one of the plurality of first reference points and a second side not including any of the plurality of first reference points, and the second side and the boundary line are separated by a second set value indicating a distance to the boundary line;
using a genetic algorithm based on a selected first gene information point set selected from the plurality of first gene information point sets to generate a plurality of second gene information point sets each including a plurality of second gene information points, in which a number of the plurality of second gene information points corresponds to the first set value;
deciding a plurality of second reference points on the boundary line for each of the plurality of second gene information point sets based on the plurality of second gene information points included in the second gene information point set;
generating a plurality of second rectangular regions for each of the plurality of second gene information point sets, in which each of the plurality of second rectangular regions includes a first side including one of the plurality of second reference points and a second side not including any of the plurality of second reference points, and the second side and the boundary line are separated by the second set value;
specifying one of the plurality of first gene information point sets and the plurality of second gene information point sets based on evaluation of the plurality of first rectangular regions generated based on the first gene information point set for each of the plurality of first gene information point sets and evaluation of the plurality of second rectangular regions generated based on the second gene information point set for each of the plurality of second gene information point sets; and
dividing the target region based on the plurality of first rectangular regions or the plurality of second rectangular regions generated according to the specified first gene information point set or second gene information point set.

11. A divided region generating method analyzing temporal variation of physical properties on a target object, the method comprising:
storing, in a memory, boundary information indicating a boundary line of a region occupied by the target object arranged in a target region and another region on a plane in the target region;
referring, by a processor, to the boundary information stored in the memory to generate a plurality of first gene information point sets each including a plurality of first gene information points, in which a number of the plurality of first gene information points corresponds to a first set value related to a degree of division of the target region;
deciding, by the processor, a plurality of first reference points on the boundary line for each of the plurality of first gene information point sets based on the plurality of first gene information points included in the first gene information point set;
generating, by the processor, a plurality of first rectangular regions for each of the plurality of first gene information point sets, in which each of the plurality of first gene rectangular regions includes a first side including one of the plurality of first reference points and a second side not including any of the plurality of first reference points, and the second side and the boundary line are separated by a second set value indicating a distance to the boundary line;
using, by the processor, a genetic algorithm based on a selected first gene information point set selected from the plurality of first gene information point sets to generate, in the memory, a plurality of second gene information point sets each including a plurality of second gene information points, in which a number of the plurality of second gene information points corresponds to the first set value;
deciding, by the processor, a plurality of second reference points on the boundary line for each of the plurality of second gene information point sets based on the plurality of second gene information points included in the second gene information point set;
generating, by the processor, a plurality of second rectangular regions for each of the plurality of second gene information point sets, in which each of the plurality of second rectangular regions includes a first side including one of the plurality of second reference points and a second side not including any of the plurality of second reference points, and the second side and the boundary line are separated by the second set value;
specifying, by the processor, one of the plurality of first gene information point sets and the plurality of second gene information point sets based on evaluation of the plurality of first rectangular regions generated based on the first gene information point set for each of the plurality of first gene information point sets and evaluation of the plurality of second rectangular regions generated based on the second gene information point set for each of the plurality of second gene information point sets;
dividing, by the processor, the target region based on the plurality of first rectangular regions or the plurality of second rectangular regions generated according to the specified first gene information point set or second gene information point set; and
analyzing the temporal variation of physical properties on the target object based on the divided target region.
